(19) United States
(12) Patent Application Publication
(10) Pub. No.: US 2023/0278257 A1
(43) Pub. Date: Sep. 7, 2023

(54) DIRECT CHARGE CONCRETE MIXER

(71) Applicant: Oshkosh Corporation, Oshkosh, WI (US)

(72) Inventor: Bryan Datema, Oshkosh, WI (US)

(73) Assignee: Oshkosh Corporation, Oshkosh, WI (US)

(21) Appl. No.: 18/116,006

(22) Filed: Mar. 1, 2023

Related U.S. Application Data
(60) Provisional application No. 63/315,671, filed on Mar. 2, 2022.

(51) Int. Cl. B28C 5/42

(52) U.S. Cl. CPC B28C 5/4268; B28C 5/4272; B28C 5/4231; B28C 5/4248; B28C 5/422; B28C 5/4265

(57) ABSTRACT

A concrete mixer vehicle includes a chassis, a mixing drum assembly, and a controller. The mixing drum assembly includes a mixing drum, a mixing element, a collector, and a chute. The mixing drum defines an aperture and a volume. The mixing element is positioned within the volume and is coupled to the mixing drum. The controller is configured to determine a state of the concrete mixer vehicle, determine a state of a mixture delivery system of a batch plant, obtain and apply a setpoint value to an actuator of the concrete mixer vehicle or the mixture delivery system, and activate the mixture delivery system to output material through the outlet of the mixture delivery system such that the material is deposited directly into the volume of the mixing drum to thereby directly charge the concrete mixer vehicle with material.

### CROSS-REFERENCE TO RELATED PATENT APPLICATIONS

This U.S. patent application claims the benefit of and priority to U.S. Provisional Application No. 63/315,671, filed Mar. 2, 2022, the entire disclosure of which is hereby incorporated by reference herein.

### BACKGROUND

The present invention relates generally to concrete mixing systems. More specifically, the present disclosure relates to charging (e.g., loading) systems for concrete mixing systems.

Concrete handling equipment typically includes a container that is configured to receive, mix, agitate, and dispense a material or a mixture of materials. In transit concrete mixer vehicles, the container is typically a drum that rotates about an axis which includes internal features that mixing and/or dispensing the contents of the drum when rotated. Typically, the open end of a drum is elevated and includes one or more structures near the opening for loading the drum with a material or mixture. Conventional structures surrounding the opening of the drum may be heavy and burdensome to clean and maintain.

### SUMMARY

At least one embodiment relates to a concrete mixer vehicle. The concrete mixer vehicle includes a chassis, a mixing drum assembly, and a controller. The mixing drum assembly is coupled to the chassis. The mixing drum assembly includes a mixing drum, a mixing element, a collector, and a chute. The mixing drum defines an aperture and a volume. The aperture receives material and the volume contains the material. The mixing element is positioned within the volume and is coupled to the mixing drum. The mixing element is configured to mix the material when the mixing drum is rotated in a first direction to thereby mix the material. The mixing element is configured to drive the material towards the aperture when the mixing drum is rotated in a second direction opposite the first direction. The collector is positioned to receive the material from the mixing drum. The chute is positioned to receive the material from the collector. The controller is configured to determine a state of the concrete mixer vehicle, determine a state of a mixture delivery system of a batch plant, and based on the state of the concrete mixer vehicle and the state of the mixture delivery system: (i) obtain a setpoint value for an actuator of the concrete mixer vehicle or the mixture delivery system, the setpoint value associated with a position of the actuator such that an outlet of the mixture delivery system is disposed within the volume, (ii) apply the setpoint value to the actuator of the concrete mixer vehicle or the mixture delivery system to position the outlet of the mixture delivery system within the volume, and (iii) activate the mixture delivery system to output material through the outlet of the mixture delivery system such that the material is deposited directly into the volume of the mixing drum to thereby directly charge the concrete mixer vehicle with the material.

Another embodiment relates to a batch plant having a frame, a cement supply, an aggregate supply, a mixture delivery system, and a controller. The mixture delivery system includes a mixture output mechanism. The mixture output mechanism has an inlet and an outlet. The outlet is selectively repositionable relative to the frame. The controller is configured to determine a state of a mixing drum proximate the outlet of the mixture output mechanism, determine a state of the mixture output mechanism, and based on the state of the mixing drum and the mixture delivery system: (i) obtain a setpoint value for an actuator of the mixture delivery system, the setpoint value associated with a position of the mixture output mechanism such that the outlet is disposed within a volume of the mixing drum, (ii) apply the setpoint value to the actuator of the mixture delivery system, and (iii) activate the mixture delivery system to dispense material directly into the volume.

Another embodiment relates to a concrete mixer vehicle. The concrete mixer vehicle includes a chassis, a mixing drum assembly, an auxiliary fluid system, a user access point coupled to the chassis, and a controller. The mixing drum assembly is coupled to the chassis. The mixing drum assembly includes a mixing drum, a mixing element, a pedestal, a collector, and a chute. The mixing drum defines an aperture and a volume. The aperture is configured to receive a material and the volume is configured to contain the material. The mixing element is positioned within the volume and is coupled to the mixing drum. The pedestal is coupled to the chassis and is configured to support the mixing drum. The pedestal defines a mount for removably attaching an accessory to the pedestal. The collector is positioned to receive material from the mixing drum. The chute is positioned to receive the material from the collector. The auxiliary fluid system includes an admixture system and a washout system. The admixture system is configured to selectively add an admixture material to the mixing drum. The washout system is configured to wash at least one of an interior of the mixing drum, an exterior surface of the mixing drum, the collector, or the chute. The controller is configured to obtain a setpoint value for an actuator of the concrete mixer vehicle, the setpoint value associated with a position of the actuator such that an outlet of a mixture delivery system of a batch plant is disposed within the volume, apply the setpoint value to the actuator of the concrete mixer vehicle, and activate the mixture delivery system of the batch plant to output material directly into the volume of the mixing drum to thereby directly charge the concrete mixer vehicle with material.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top, left perspective view of a direct charge concrete mixer truck, according to an exemplary embodiment.

FIG. 2 is a left side view of the direct charge concrete mixer truck of FIG. 1, according to an exemplary embodiment.

FIG. 3 is right side view of a direct charge concrete mixer truck, according to an exemplary embodiment.

FIG. 4 is a rear, right side view of a direct charge concrete mixer truck of FIG. 1, according to an exemplary embodiment.

FIG. 5 is detail view of the direct charge mixing drum of FIG. 1, according to an exemplary embodiment.

FIG. 6 is a perspective view of the direct charge concrete mixer truck of FIG. 1, according to an exemplary embodiment.

FIG. 7 is a side elevational view of a concrete batch plant for charging the direct charge concrete mixer truck of FIG. 1, according to an exemplary embodiment.

FIG. 8 is a schematic of a batch plant, according to an exemplary embodiment.

FIG. 9 is a schematic of the batch plant of FIG. 8 and a direct charge concrete mixer truck of FIG. 1, according to an exemplary embodiment.

FIG. 10 is a detail view of the batch plant of FIG. 8 and the direct charge mixer truck of FIG. 1, according to an exemplary embodiment.

FIG. 11 is a detail view of a the batch plant of FIG. 8, according to an exemplary embodiment.

FIG. 12 is a detail view of the batch plant of FIG. 8, according to an exemplary embodiment.

FIG. 13 is a detail view of a portion of the batch plant of FIG. 8, according to an exemplary embodiment.

FIG. 14 is a detail view of a portion of the batch plant of FIG. 8, according to an exemplary embodiment.

FIG. 15 is a detail view of the batch plant of FIG. 8 and the direct charge concrete mixer truck of FIG. 1, according to an exemplary embodiment.

FIG. 16 is a detail view of the batch plant of FIG. 8 and the direct charge concrete mixer truck of FIG. 1, according to an exemplary embodiment.

FIG. 17 is a detail view of the batch plant of FIG. 8 and the direct charge concrete mixer truck of FIG. 1, according to an exemplary embodiment.

FIG. 18 is a detail view of a portion of the direct charge concrete mixer truck of FIG. 1, according to an exemplary embodiment.

FIG. 19 is a detail view of a portion of the direct charge concrete mixer truck of FIG. 1, according to an exemplary embodiment.

FIG. 20 is a detail view of a portion of the direct charge concrete mixer truck of FIG. 1, according to an exemplary embodiment.

FIG. 21 is a detail view of a portion of the direct charge concrete mixer truck of FIG. 1 and a portion of the batch plant of FIG. 8, according to an exemplary embodiment.

FIG. 22 is a detail view of a portion of the direct charge concrete mixer truck of FIG. 1, according to an exemplary embodiment.

FIG. 23 is a detail view of a portion of the direct charge concrete mixer truck of FIG. 1 and a portion of the batch plant of FIG. 8, according to an exemplary embodiment.

FIG. 24 is a detail view of a portion of the direct charge concrete mixer truck of FIG. 1, according to an exemplary embodiment.

FIG. 25 is a detail view of a portion of the direct charge concrete mixer truck of FIG. 1, according to an exemplary embodiment.

FIG. 26 is a detail view of a portion of the direct charge mixer truck of FIG. 1, according to an exemplary embodiment.

FIG. 27 is a detail view of a portion of the direct charge mixer truck of FIG. 1, according to an exemplary embodiment.

FIG. 28 is a detail view of a portion of the direct charge mixer truck of FIG. 1, according to an exemplary embodiment.

FIG. 28 is a detail view of a portion of the direct charge mixer truck of FIG. 1, according to an exemplary embodiment.

FIG. 29 is a detail view of a portion of the direct charge mixer truck of FIG. 1, according to an exemplary embodiment.

FIG. 30 is a detail view of a portion of the direct charge mixer truck of FIG. 1 and a portion of the batch plant of FIG. 8, according to an exemplary embodiment.

FIG. 31 is a detail view of a portion of the direct charge mixer truck of FIG. 1, according to an exemplary embodiment.

FIG. 32 is a block diagram of a direct charge system, according to an exemplary embodiment.

FIG. 33 is a block diagram of a portion of the direct charge system of FIG. 32, according to an exemplary embodiment.

FIG. 34 is a flow diagram of a method for controlling the direct charge system of FIG. 32, according to an exemplary embodiment.

FIG. 35 is a flow diagram of a method for controlling the direct charge system of FIG. 32, according to an exemplary embodiment.

FIG. 36 is a flow diagram of a method for controlling the direct charge system of FIG. 32, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a system includes a concrete mixer truck, a batch plant, and a direct charge control system. The concrete mixing truck may include a direct charge mixing drum assembly and an auxiliary fluid system. The direct charge mixing drum assembly may include a mixing drum, a mixing element, a collector, and a chute. The auxiliary fluid system may include a washout system, an admixture system, and a water add system. The direct charge batch plant may include a frame, a cement supply, an aggregate supply, a liquid supply and mixture delivery system. The mixture delivery system may include a chute for directing material directly into the mixing drum of the direct charge mixing drum assembly via an opening in the mixing drum. The position and orientation of the chute and the components thereof may be controllable. The batch plant may include an adjustment system for manipulating a position or orientation of the concrete mixing truck. The direct charge mixing drum assembly may include one or more actuators configured to manipulate the orientation and position of the mixing drum relative to the chute.

The control system may include a controller that is configured to operate one or more systems of the concrete mixer truck and/or the batch plant. Various components, systems, and subsystems of the concrete mixer truck and the direct charge batch plant may be connected to the controller. The controller may have one or more processors and one or more memory devices storing instructions thereon that cause the one or more processors to perform one or more of the processes and operations described herein.

### Overall Vehicle

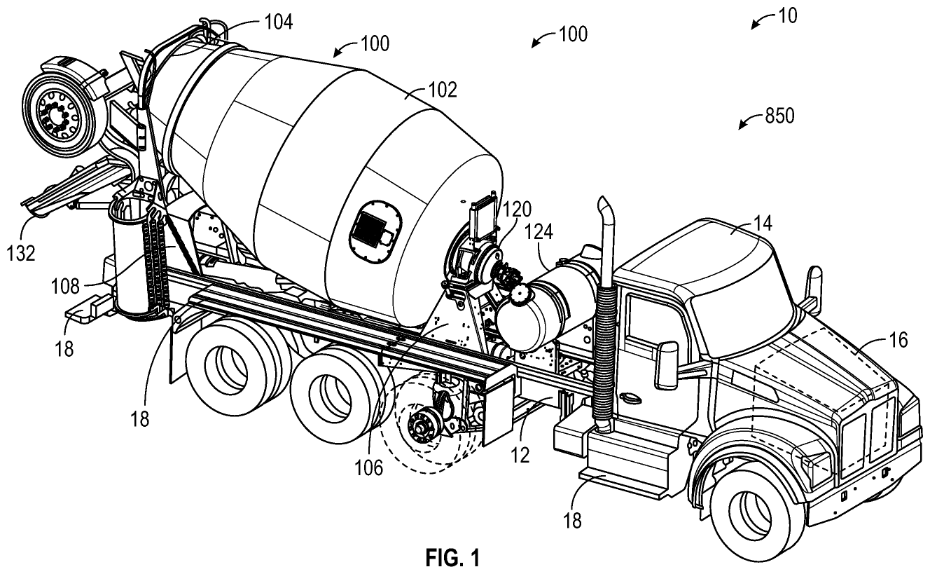

Referring to FIGS. 1-4, a vehicle, shown as concrete mixer truck 10, includes a chassis, shown as frame 12, and a cab, body, cabin, or personnel compartment, shown as cab 14, coupled to the frame 12 (e.g., at a front end thereof with respect to the main direction of travel). The frame 12 extends longitudinally along a length of the concrete mixer truck 10 (e.g., from a front end to a rear end, along a longitudinal axis that extends in a direction of travel, etc.). The frame 12 may include one or more frame rails. The cab 14 is configured to hold one or more occupants (e.g., a driver or operator and/or one or more passengers, etc.). The cab 14 may include various components to facilitate operation of the concrete mixer truck 10 by an operator (e.g., a seat, a steering wheel, hydraulic controls, a user interface, switches, buttons, dials, etc.).

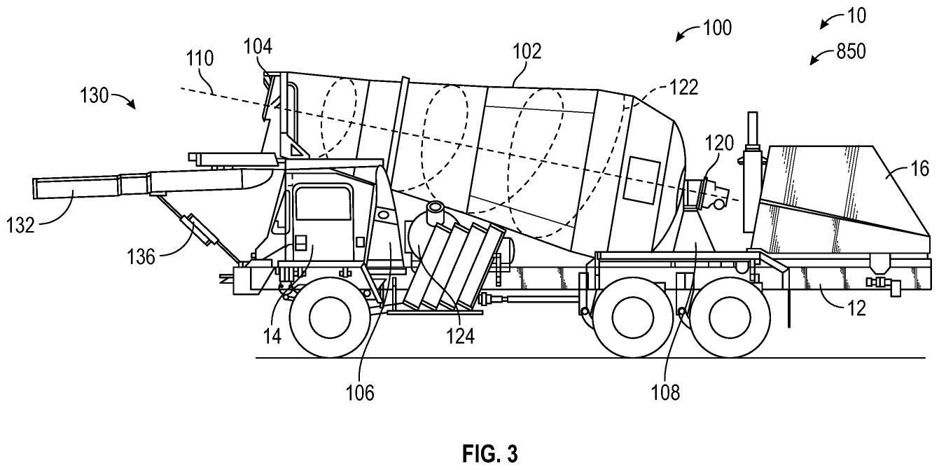

As shown in FIGS. 1-3, the concrete mixer truck 10 includes a prime mover, shown as engine 16. The engine 16 is configured to supply mechanical energy (e.g., rotational mechanical energy) to power one or more functions of the concrete mixer truck 10 (e.g., propelling the concrete mixer truck 10, driving the mixing drum 102, etc.). In the embodiment of FIG. 1, the engine 16 is coupled to the frame 12 adjacent the cab 14 (e.g., at a front end of the cab 14, at a front end of the concrete mixer truck 10). In the embodiment shown in FIG. 3, the engine 16 is coupled to the frame 12 at a rear end of the concrete mixer truck 10. The engine 16 may be configured to utilize one or more of a variety of fuels (e.g., gasoline, diesel, bio-diesel, ethanol, natural gas, etc.), according to various exemplary embodiments. Additionally or alternatively, the prime mover may include one or more electric motors and/or generators, which may be coupled to the frame 12 (e.g., as a hybrid vehicle, an electric vehicle, etc.). The electric motors may consume electrical power from an on-board storage device (e.g., batteries, ultra-capacitors, etc.), from an on-board generator (e.g., an internal combustion engine, a genset, solar panel, etc.), and/or from an external power source (e.g., overhead power lines, etc.) and provide power (e.g., rotational mechanical energy) to systems of the concrete mixer truck 10.

The concrete mixer truck 10 may also include a transmission that is coupled to the engine 16. The engine 16 produces mechanical power (e.g., due to a combustion reaction, etc.) that may flow into the transmission. The concrete mixer truck 10 may include a vehicle drive system that is coupled to the transmission. The vehicle drive system may include drive shafts, differentials, and other components coupling the transmission with a ground surface to move the concrete mixer truck 10. The concrete mixer truck 10 may also include a plurality of tractive elements, such as wheels, that engage a ground surface to move the concrete mixer truck 10. In one embodiment, at least a portion of the mechanical power produced by the engine 16 flows through the transmission and into the vehicle drive system to power at least some of the wheels (e.g., front wheels, rear wheels, etc.). In one embodiment, energy (e.g., mechanical energy, etc.) flows along a power path defined from the engine 16, through the transmission, and to the vehicle drive system.

### Drum Assembly

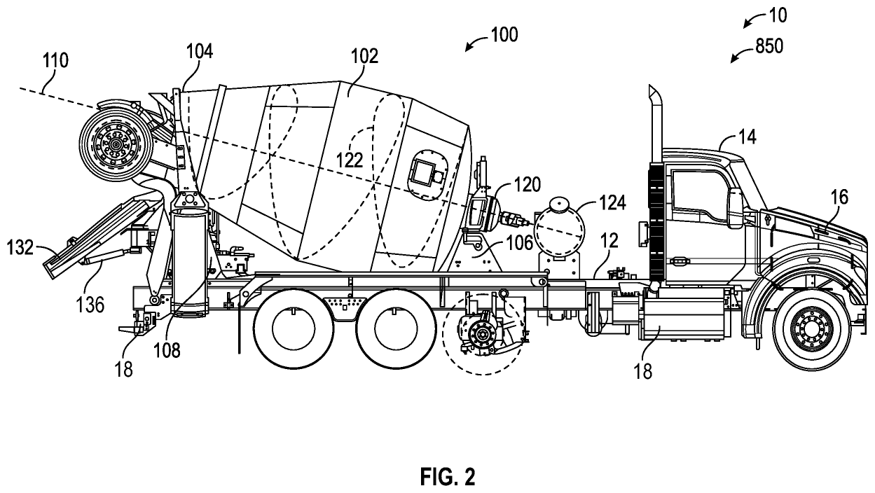

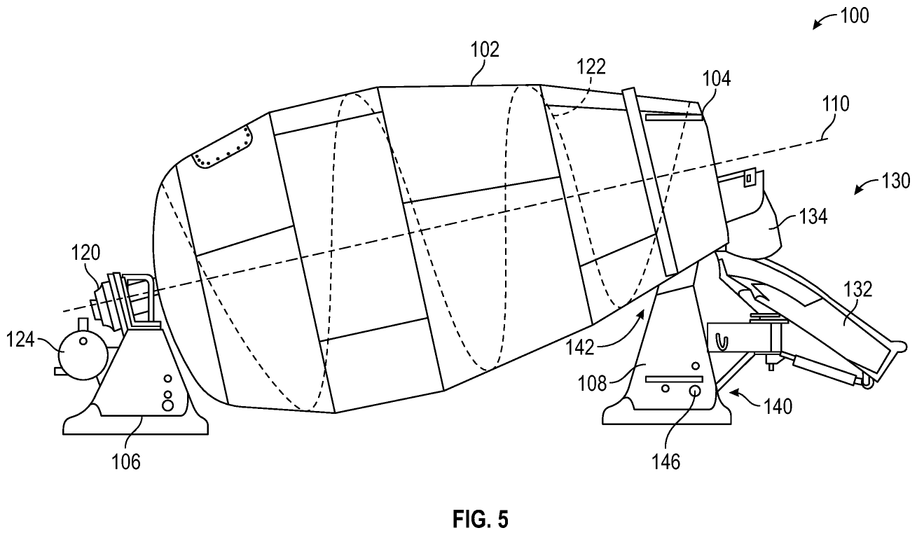

As shown in FIGS. 1-6, the concrete mixer truck 10 includes a direct charge container, payload container, a mixing assembly, a mixing drum assembly, or equipment, shown as direct charge drum assembly 100. The direct charge drum assembly 100 is configured to directly receive and mix dry ingredients (e.g., cementitious material, aggregate, sand, etc.) and water to form a wet concrete mixture, which can be transported to a job site. The direct charge drum assembly 100 then dispenses the concrete at the job site (e.g., for use in forming one or more structures, such as buildings, roads, or foundations). The direct charge drum assembly 100 includes a mixing drum, shown as mixing drum 102. The mixing drum 102 is coupled to the frame 12 and disposed behind the cab 14 (e.g., at a rear and/or middle of the frame 12, etc.). The mixing drum 102 defines an inlet/outlet, shown as mixing drum aperture 104, through with material enters and exits the mixing drum 102. In the embodiment shown in FIGS. 1 and 2, the mixing drum aperture 104 is positioned at a rear end of the frame 12 (i.e., the concrete mixer truck 10 is a rear discharge concrete mixer truck). In the embodiment shown in FIG. 3, the mixing drum 102 extends over the cab 14, and the mixing drum aperture 104 is positioned at the front end of the frame 12 (i.e., the concrete mixer truck 10 is a front discharge concrete mixer truck).

As shown in FIGS. 1-6, 8-10, and 15-17, the concrete mixer truck 10 includes a first support, shown as front pedestal 106, and a second support, shown as rear pedestal 108. According to an exemplary embodiment, the front pedestal 106 and the rear pedestal 108 rotatably couple the mixing drum 102 to the frame 12. By way of example, one or both of the pedestals may include one or more bearings that engage an outer surface of the mixing drum 102. The mixing drum 102 is configured to rotate relative to the frame 12 about a central, longitudinal axis of rotation, shown as axis 110. In some embodiments, the axis 110 is oriented generally upward as the mixing drum 102 extends toward the mixing drum aperture 104 to facilitate retaining the mixture within the mixing drum 102. As shown in FIGS. 2-3, 5, 9-10, and 15-16, the axis 110 is angled relative to the frame 12 such that the axis 110 intersects a horizontal plane extending along a top of the frame 12. According to an exemplary embodiment, the axis 110 is elevated from the frame 12 at an angle in the range of five degrees to twenty degrees. In other embodiments, the axis 110 is elevated by less than five degrees (e.g., four degrees, three degrees, etc.) or greater than twenty degrees (e.g., twenty-five degrees, thirty degrees, etc.). In some embodiments, the concrete mixer truck 10 includes one or more actuators positioned to adjust the position and orientation of axis 110 to a desired or target angle (e.g., manually in response to an operator input/command, automatically according to a control scheme, etc.).

According to an exemplary embodiment, direct charge drum assembly 100 includes a rotational actuator (e.g., an electric motor, a hydraulic motor, etc.), shown as drum motor 120. The drum motor 120 is configured to drive rotation of the mixing drum 102 about the axis 110. In some embodiments, the drum motor 120 is powered by the engine 16. By way of example, the engine 16 may drive a pump that provides a flow of pressurized hydraulic fluid to the drum motor 120. In other embodiments, the drum motor 120 is an electric motor that consumes electrical energy (e.g., from an energy storage device, such as a battery, from a generator coupled to the engine 16, etc.). The drum motor 120 may rotatably couple the mixing drum 102 to the front pedestal 106 (e.g., as shown in FIG. 1) or to the rear pedestal 108 (e.g., as shown in FIG. 3). In some embodiments, the drum motor 120 is pivotably coupled to the front pedestal 106 or to the rear pedestal 108 to facilitate the axis 110 pivoting relative to the frame 12.

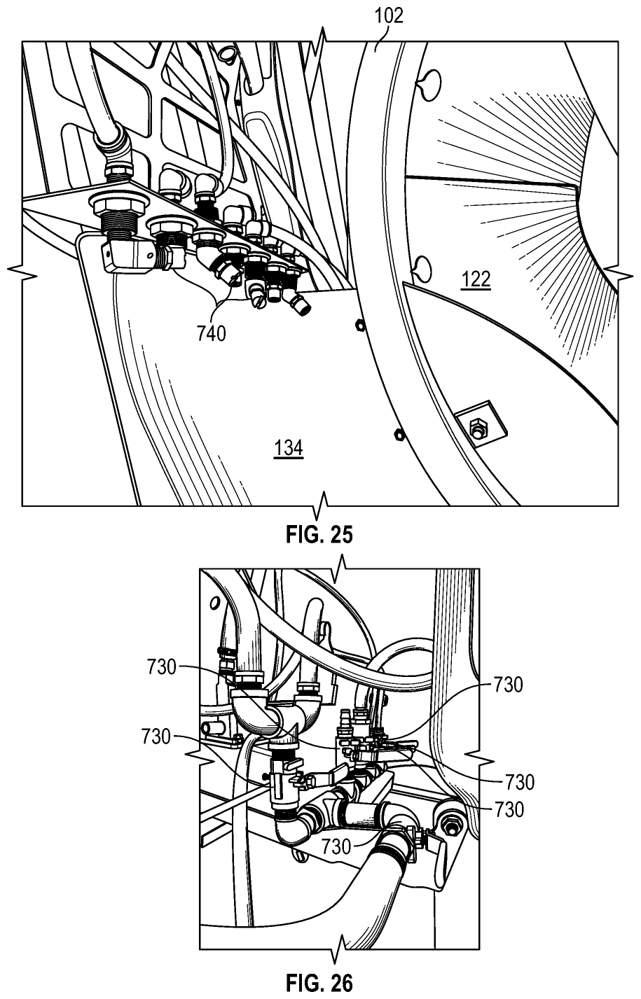

As shown in FIGS. 2-3, 5, 9-10, 15-16, and 19-25 the direct charge drum assembly 100 includes at least one internal protrusion (e.g., a ridge, a fin, a plate, etc.), shown as mixing element 122. The mixing element 122 extends inward from an internal surface of the mixing drum 102 such that the mixing element 122 agitates the mixture within the mixing drum 102 when the mixing drum 102 is rotated (e.g., by the drum motor 120). The mixing element 122 extends longitudinally along a length of the mixing drum 102. In some embodiments, the mixing element 122 is shaped (e.g., helical or spiral-shaped) such that the mixing element 122 (a) drives the mixture toward the mixing drum aperture 104 when driven in a first rotational direction (e.g., clockwise) and (b) drives the mixture away from the mixing drum aperture 104, agitating the mixture, when driven in a second rotational direction opposite the first rotational direction (e.g., counterclockwise). Accordingly, the drum motor 120 is configured to control whether the mixture is agitated or dispensed by controlling the direction of rotation of the mixing drum 102.

As shown in FIGS. 1-6, the direct charge drum assembly 100 includes a container or vessel, shown as fluid tank 124, that contains a volume of fluid (e.g., water, admixture material, cleaning solution, etc.). The fluid tank 124 may selectively (e.g., as controlled by a pump and/or valve) supply water to the mixing drum 102 to control a characteristic (e.g., consistency, slump, etc.) of the mixture within the mixing drum 102. In some embodiments, the fluid tank 124 is a multiple fluid tank (e.g., a composite tank, a compartmentalized tank, etc.) that is configured to contain one or more liquids within the tank. For example, the fluid tank 124 may store a volume of water in a first compartment, and store a second volume of fluid (e.g., wash mixture, admixture, cleaning fluid, wash fluid, etc.) in a second compartment. In some embodiments, the concrete mixer truck 10 includes more than one fluid tank 124, and each fluid tank 124 may store one or more fluids. For example, the concrete mixer truck 10 may include a fluid tank 124 for storing water and may include another fluid tank 124 for storing a chemical or fluid (e.g., an admixture material, washout fluid, etc.).

In some embodiments, the fluid tank 124 is made of a lightweight material or a combination of lightweight materials. For example, the fluid tank 124 may be at least partially made from a lightweight composite material (e.g., a fiber-reinforced composite) and/or an aluminum or titanium alloy to reduce the weight of the fluid tank 124. In some embodiments, one or more of the components of the concrete mixer truck 10 made of a lightweight material (e.g., non-ferrous metals, non-ferrous metal alloys, carbon fiber, etc.), or a composite material (e.g., a layered composite material, a fiber-reinforced composite, a fiber-reinforced polymer, fiberglass, etc.) to reduce the weight of the component and thereby reduce the weight of the concrete mixer truck 10.

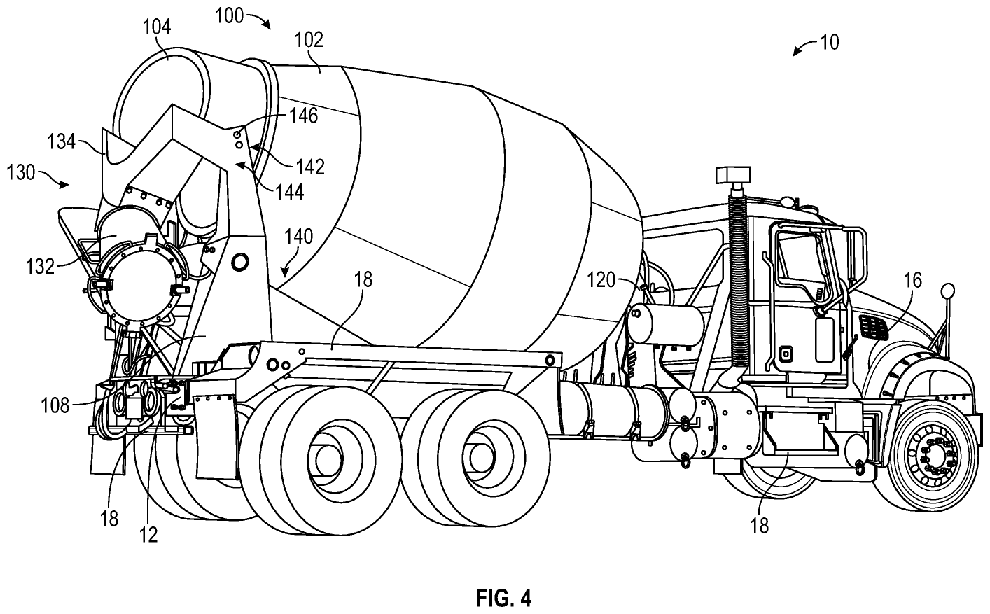

As shown in FIGS. 1-6, the direct charge drum assembly 100 further includes an outlet assembly 130. The outlet assembly 130 may include a chute assembly 132 coupled to the frame 12. The chute assembly 132 may be positioned at the mixing drum aperture 104 such that the chute assembly 132 receives material (e.g., the concrete mixture) discharged from the mixing drum 102. The chute assembly 132 may be selectively repositioned by an operator to control the trajectory of the material. In some embodiments, the chute assembly 132 includes one or more actuators (e.g., linear actuators, hydraulic actuators, hydraulic cylinders, etc.), shown as chute actuators 136 which facilitate a user controlling the trajectory of the material. In some embodiments, the chute actuators 136 are electronically controllable. For example, chute actuators 136 may be in communication with a controller (e.g., a microcontroller, a processing circuit, one or more processors in communication with one or more memory devices storing instructions thereon that when executed by the one or more processors cause the one or more processors to perform one or more operation, a hydraulic system controller, etc.). In some embodiments, the direct charge drum assembly 100 further includes a funnel or fluid directing device, shown as collector 134, that is positioned between the mixing drum aperture 104 and the chute assembly 132. The collector 134 may be positioned and sized to receive the material discharged from the mixing drum aperture 104 and direct the material to the chute assembly 132. In some embodiments, the collector 134 is coupled to at least one of the pedestals 106, 108. As shown in FIGS. 4-6, the chute assembly 132 is coupled to the rear pedestal 108.

As shown in FIG. 4-6, the rear pedestal 108 includes a base portion 140 that is fixedly coupled (e.g., welded, bonded, bolted, etc.) to the frame 12. The base portion 140 may be shaped and sized to support the mixing drum 102, collector 134, chute assembly 132, and/or other components of the direct charge drum assembly 100. In some embodiments, the base portion 140 is configured to rotatably couple with and support the mixing drum 102. For example, the base portion 140 may include at least one bearing that is positioned and sized to support the mixing drum 102. In some embodiments the base portion 140 includes three bearings. As shown in FIGS. 4-6, the rear pedestal 108 includes a top portion 142 (e.g., upper portion, upper end, etc.) that extends above the base portion 140. The top portion 142 may include a flange 144. The flange 144 may be shaped and sized to facilitate coupling the collector 134 to the rear pedestal 108. In some embodiments, the flange 144 is fixedly coupled to the collector 134. In some embodiments, the flange 144 forms at least a portion of the collector 134.

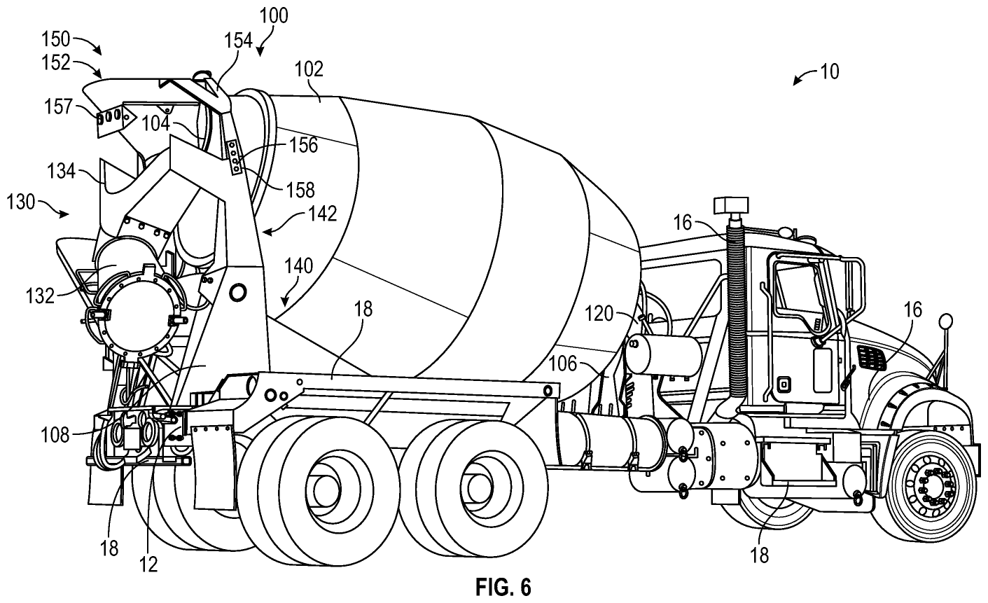

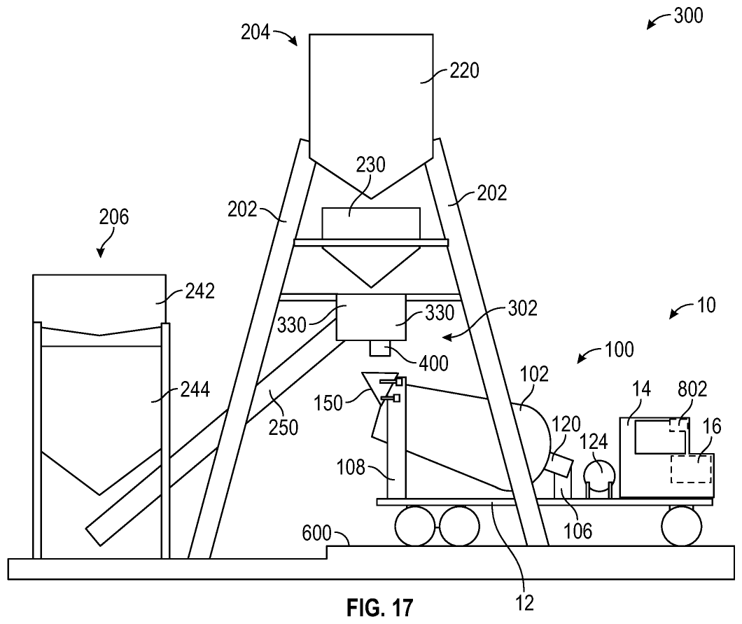

As shown in FIGS. 4-6, the top portion 142 includes an accessory mount, shown as mounting apertures 146. Mounting apertures 146 may facilitate removably coupling an accessory (e.g., a funnel, a charge hopper, an axillary light source, a speaker, a sensor, a camera, a washout system, a spray head, an auxiliary tank, a ladder, an auxiliary chute, a solar panel, etc.) shown as hopper 150, to the rear pedestal 108. As shown in FIGS. 6 and 17, the hopper 150 may include a funnel portion 152 that is shaped and sized to direct material into the mixing drum 102 through the mixing drum aperture 104. The hopper 150 may include a rigid support arm 154 coupled to the funnel portion 152. The rigid support arm 154 may include features that correspond to an accessory mount of the rear pedestal 108 (e.g., mounting apertures 146). For example, as shown in FIG. 6, the rigid support arm 154 includes a mounting plate 156 having mounting plate apertures 158 that are positioned and sized to align with mounting apertures 146. One or more of the mounting apertures 146 or the mounting plate apertures 158 may be treaded. In some embodiments, at least a portion of the rigid support arm 154 is configured to slot into or otherwise engage the rear pedestal 108. The hopper 150 may include electronic devices (e.g., sensors, lights, speakers, cameras, actuators, etc.), shown as auxiliary lights 157, which may support an operation of a system of the concrete mixer truck 10. For example, the auxiliary lights 157 may supplement the lighting system of the concrete mixer truck 10. Auxiliary lights 157 may be or include running lights, brake lights, spot lights, turn signals, flood lights, clearance lights, cameras, speakers, emitters, receivers, or other electronic devices. In some embodiments, rear pedestal 108 includes one or a combination of one or more apertures, flanges, slots, grooves, or other suitable structures that facilitate coupling an accessory to the rear pedestal 108. In some embodiments, the front pedestal 106 has some or all of the features of the rear pedestal 108.

In some embodiments, the rear pedestal 108 and/or the front pedestal 106 are shaped and sized to support the mixing drum 102 and do not include user access structures (e.g., an elevated user platform, a user platform, guide rail, a user access ladder, etc.). Advantageously, the rear pedestal 108 and/or the front pedestal 106 may facilitate a reduced weight of the direct charge drum assembly 100, which may facilitate an improved payload capacity and efficiency of the concrete mixer truck 10. In some embodiments, the access structures (e.g., ladders, platform, guiderail, grab-bar, etc.) may be removably coupled to the rear pedestal 108 and/or the front pedestal 106.

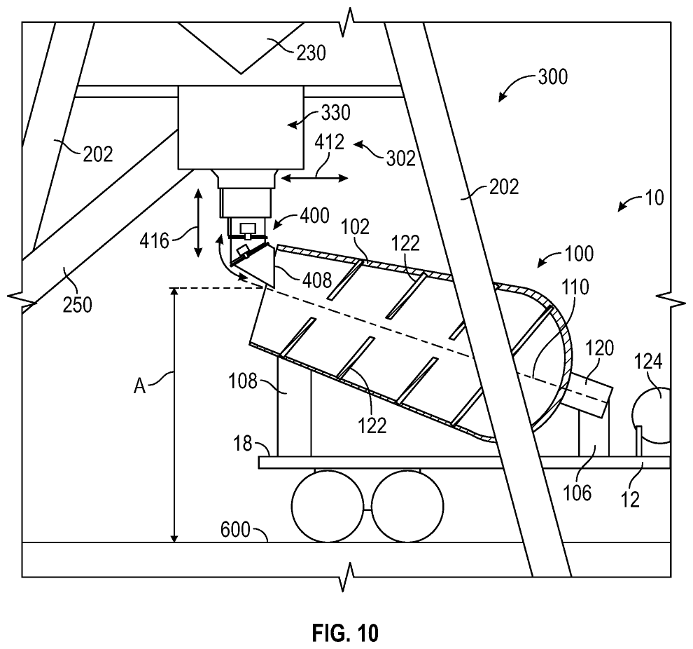

In some embodiments, the concrete mixer truck 10 includes one or more user access points or portions, shown as user access point 18. User access point 18 may be shaped and sized to support at least the weight of a user. In some embodiments, the user access points 18 may enable a user to access one or more locations of the concrete mixer truck 10. For example, a user may utilize a user access point 18 to reach an area of the concrete mixer truck 10 that is difficult for a user to access (e.g., view, clean, wash, spray, etc.) from the ground. For example, a user may utilize (e.g., stand on, grab, rest on, lean on, walk on, jump on, etc.) a user access point (e.g., a platform, a reinforced area, a walkway, a ladder, a hatch, etc.) of a component of the concrete mixer truck 10 (e.g., a front bumper, a rear bumper, a fender, a frame 12, a wheel, a chute, etc.) to access one or more portions of the concrete mixer truck 10 (e.g., a top of the cab 14, a surface or component of the direct charge drum assembly 100, etc.). In some embodiments, one or more of the user access points 18 are a fixed structure (e.g., a step formed into a bumper, a platform fixedly coupled to the frame 12, etc.). In other embodiments, one or more of the user access points 18 are storable, foldable, removable, collapsible, or retractable. For example, an user access point 18 may be or include a retractable or foldable step coupled to (e.g., pivotably coupled to), a portion of the concrete mixer truck 10. As shown in FIG. 10, the concrete mixer truck 10 includes a user access point 18 coupled to the rear end of the frame 12, a user access point 18 formed on top of a fender coupled to the frame 12, and a user access point 18 coupled to the frame 12 near the cab 14. In some embodiments, a user access point 18 may engage (e.g., slidably engage) with a portion of the concrete mixer truck 10. For example, an user access point 18 may engage a groove, slot, channel, boss, detent, and/or other feature of the concrete mixer truck 10.

In some embodiments, a portion of the direct charge drum assembly 100 may engage with a chute of a batch plant such that virtually no material is misplaced (e.g., deposited, splattered, splashed, sloshed, etc., outside of the mixing drum 102) by the chute of the batch plant. For example, a chute (e.g., chute 400) of a batch plant (e.g., batch plant 300) may be repositionable to accommodate a position and orientation of a mixing drum 102 to directly deposit materials into the mixing drum 102. In some embodiments, the chute may enter into a portion of the direct charge drum assembly 100, or may engage a chute coupler (e.g., quick connect). Such engagement between a chute of a batch plant and the direct charge drum assembly 100 may facilitate a reduction in the frequency of an operator automatically and/or manually cleaning misplaced materials from a concrete mixer truck 10. For example, an operator of a direct charge drum assembly 100 may avoid cleaning the concrete mixer truck 10 following a charging operation (e.g., a drum loading operation, etc.) because of a lack of misplaced material during a charging operation of the direct charge drum assembly 100. Additionally, according to some embodiments, the direct charge drum assembly 100 does not include components or structures that divert material from the batch plant into the mixing drum 102 during a charging operation of the mixing drum 102. In such embodiments, the direct charge drum assembly 100 does not require cleaning or washing following a drum loading operation. According to various embodiments, the direct charge drum assembly 100 may provide for an improved concrete handling process and user experience and may improve the overall efficiency of the concrete mixer truck 10 (e.g., by reducing weight, by reducing cleaning frequency, by reducing fluid storage requirements for cleaning and washing operations, by requiring less operator time and labor, by reducing water usage during washing, etc.).

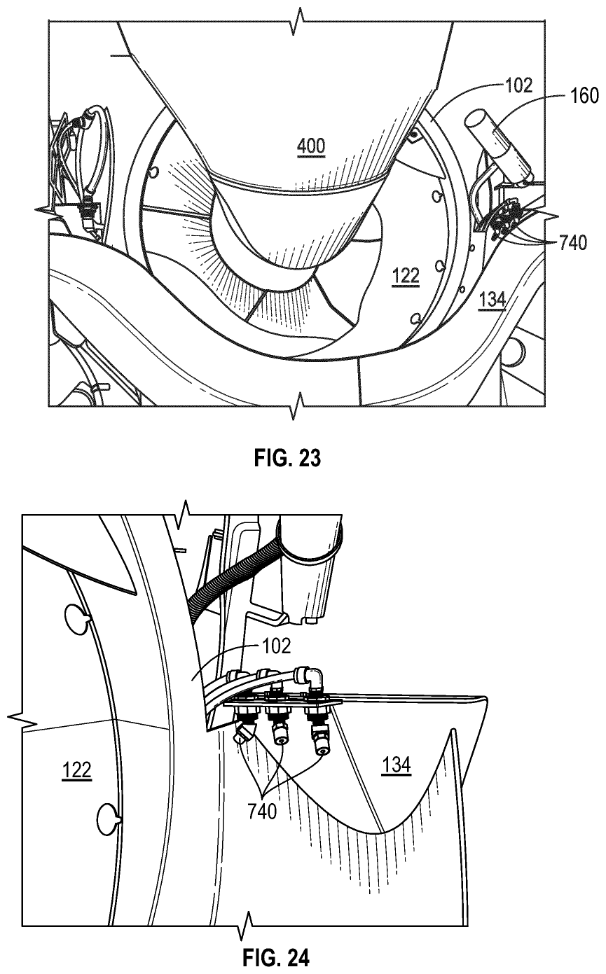

In some embodiments, the direct charge drum assembly 100 includes one or more electronic positioning devices (e.g., emitters, receivers, sensors, etc.) configured to facilitate a corresponding electronic positioning device (e.g., a corresponding receiver, emitter, etc.) to facilitate a material dispensing device of the batch plant to determine a suitable position and orientation for delivering materials directly into the direct charge drum assembly 100. As shown in FIG. 23, the mixing drum assembly includes a an electronic positioning device (e.g., position sensor, emitter, receiver, etc.), shown as drum charging sensor 160. In some embodiments, the drum charging sensor 160 may be or includes a camera that detects a position and orientation of a mixture output device of a batch plant. The drum charging sensor 160 may be used by a controller or operator to monitor and determine a position of a mixture output device of a batch plant, as described in detail below.

### Direct Charge Batch Plant

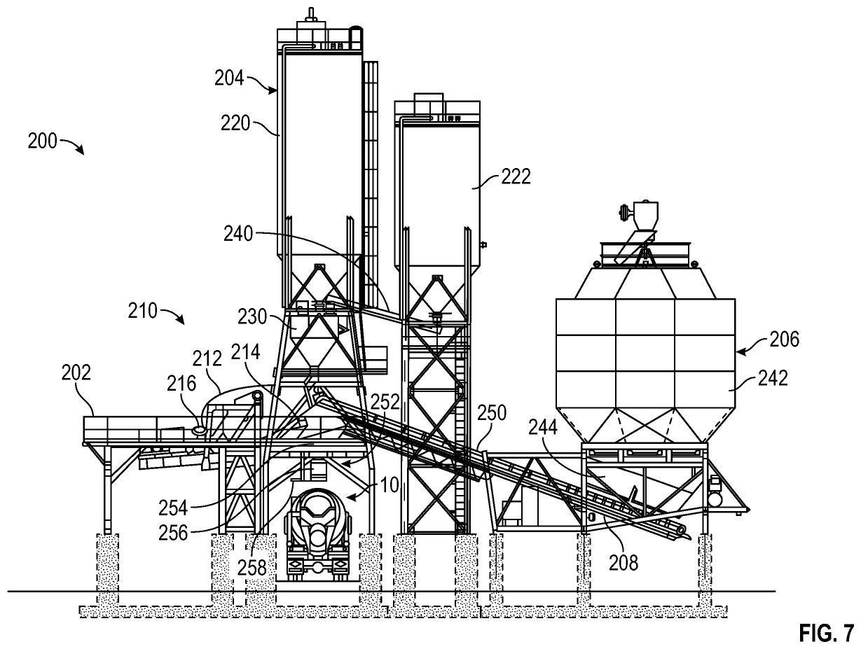

As shown in FIGS. 7-17, a concrete batch plant (e.g., concrete batching plant, concrete plant), shown as batch plant 200, includes frame 202, cement supply 204, aggregate supply 206, liquid supply 208, and a direct charge drum assembly 100. In some embodiments, batch plant 200 includes a batch plant mixer system 210. Batch plant mixer system 210 may include some or all of the features described with respect to the direct charge drum assembly 100. As shown, the batch plant mixer system 210 may include a mixing drum 212 supported by a pedestal 214. The mixing drum 212 may be rotated about a central axis by a drum motor 216. The mixing drum 212 may include at least one internal protrusion that facilitates mixing or agitating a mixture within the mixing drum 212. In some embodiments, the batch plant mixer system 210 uses motions other than rotation to mix the contents of the mixing drum 212. For example, the batch plant mixer system 210 may use vibrations, oscillations, or other motions in place of or in addition to a rotational motion to combine the materials into a mixture within the mixing drum 212.

In some embodiments, cement supply 204 includes one or more mechanisms and storage structures configured to supply cement to the concrete mixer truck 10. As shown, cement supply 204 includes main silo 220, auxiliary silo 222 and cement apportioning device 230. Silo 220 is supported by frame 202 and is configured to contain and store a supply of cement. Silo 220 is located above apportioning device 230 such that cement from silo 220 may be delivered to apportioning device 230 using gravity. Auxiliary silo 222 comprises an auxiliary source of cement or an additional source for a distinct type or kind of cement. Silo 220 includes a transport system 240 configured to deliver cement or other material from auxiliary silo 222 to apportioning device 230.

In some embodiments, apportioning device 230 includes a device configured to apportion or measure out defined quantities of cement or other materials from silo 220 and/or silo 222. As shown, apportioning device 230 comprises a cement batcher configured to weigh a quantity of cement or other material from silo 220 and/or silo 222 prior to the apportioned quantity of material from silos 220 and/or 222 from being allowed to travel under the force of gravity or by other means into batch plant mixer system 210.

In some embodiments, aggregate supply 206 includes one or more mechanisms and storage structures configured to supply one or more types of aggregate to concrete mixer truck 10. As shown, aggregate supply 206 includes bin 242, apportioning device 244 and transport mechanism 250. Bin 242 includes a storage structure configured to contain one or more aggregate. As shown, bin 242 is configured to contain four distinct aggregate types. Bin 242 is generally located above apportioning device 244 such that aggregate from bin 242 may be delivered to apportioning device 244.

In some embodiments, apportioning device 244 includes a device configured to apportion or measure out predefined quantities of one or more aggregate for supply to concrete mixer truck 10. As shown, apportioning device 244 includes an aggregate batcher configured to weigh out quantities of aggregate. In some embodiments, other devices may be used to measure out quantities, such as volume, of aggregate from bin 242. Apportioning device 244 may be supported by frame 202 above transport mechanism 250 such that aggregate may be delivered using gravity to transport mechanism 250.

In some embodiments, transport mechanism 250 includes a device configured to transport and deliver aggregate from bin 242 to concrete mixer truck 10. As shown, transport mechanism 250 includes a conveyor. In other embodiments, bin 242 (e.g., aggregate bin) may alternatively be located above concrete mixer truck 10 while silo 220 and silo 222 utilize transport mechanism 250 for delivering material to concrete mixer truck 10. In still other embodiments, cement supply 204 and aggregate supply 206 may alternatively have other configurations. For example, both cement supply 204 and aggregate supply 206 may share a transport mechanism 250 for delivering materials to concrete mixer truck 10. In still other embodiments, cement supply 204 may omit silos 220 and 222 or aggregate supply 206 may omit bin 242, wherein materials are simply unloaded from a vehicle or other source into apportioning devices 230 and 244. In still another embodiment, a single apportioning device may be utilized to measure both aggregate and cement being supplied to transport mechanism 250 for delivery to concrete mixer truck 10. In still yet other embodiments, cement supply 204 and aggregate supply 206 may merely include transport mechanism 250 configured to transport and deliver cement and aggregate supplied to it to concrete mixer truck 10.

In some embodiments, liquid supply 208 includes one or more mechanisms configured to supply liquid, such as water, to batch plant mixer system 210 and/or concrete mixer truck 10. As shown, liquid supply 208 includes a fluid meter and a series of fluid conduits such as piping or tubing, which connect the flow of fluid to the batch plant mixer system 210. In some embodiments, transport mechanism 250 is configured to transport the cement from the cement supply 204 and/or the aggregate from the aggregate supply 206 directly into the concrete mixer truck 10. In other embodiments, transport mechanism 250 is configured to transport the cement from the cement supply 204 and/or the aggregate from the aggregate supply 206 to the batch plant mixer system 210. In such embodiment, the batch plant mixer system 210 may be configured to at least partially mix at a portion of the materials before the materials are delivered to the concrete mixer truck 10. In some embodiments, the pedestal 214 is configured to selectively reposition the mixing drum 212 between a loading positon, a mixing position and a dispensing position. In the dispensing position, the mixing drum 212 may deliver (e.g., pour, dump, etc.) material into the concrete mixer truck 10.

In some embodiments, the mixing drum 212 may dispense material into a batch plant dispensing mechanism 252. The batch plant dispensing mechanism may include a collector 254 for collecting and directing material from the transport mechanism 250 and/or the batch plant mixer system 210 into a chute, pipe, duct, and/or channel shown as chute 256. The chute 256 may include one or more actuators for changing the shape, orientation, and position of the chute 256 such that the trajectory of material transported to the batch plant dispensing mechanism 252 is as desired (e.g., directed into the mixing drum 102 through the mixing drum aperture 104). In some embodiments, the chute 256 includes a dispenser flow regulation mechanism 258 configured to at least partially block, control, and/or prevent a flow of material through the chute 256. For example, material may flow through chute 256 due to gravitational forces, and dispenser flow regulation mechanism 258 may be configured to at least partially block a cross sectional area of the chute 256 perpendicular to the flow of material through chute 256. The dispenser flow regulation mechanism 258 may include one or more actuators. The dispenser flow regulation mechanism 258 may be in communication with a controller (e.g., processing circuit, microcontroller, etc.) and may be automatically controlled.

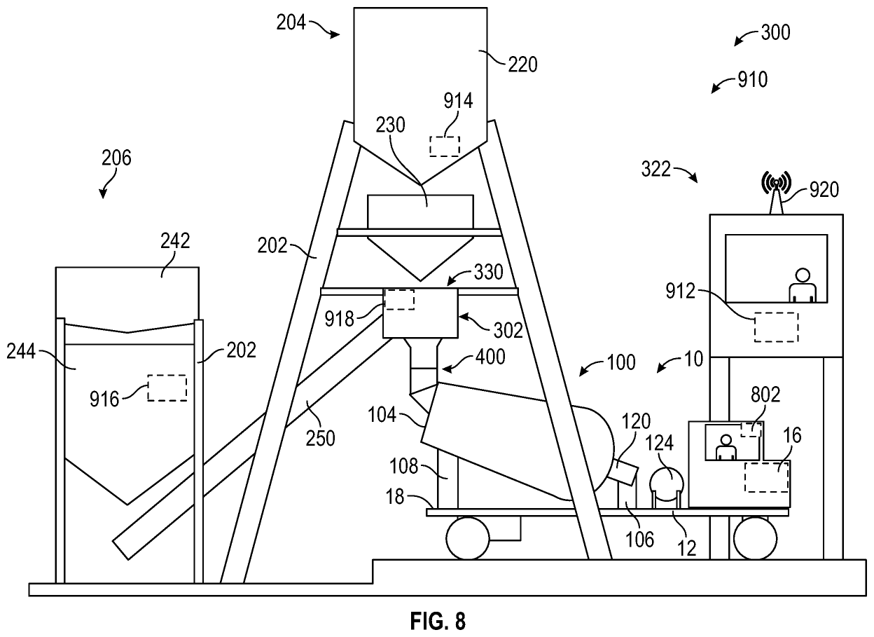

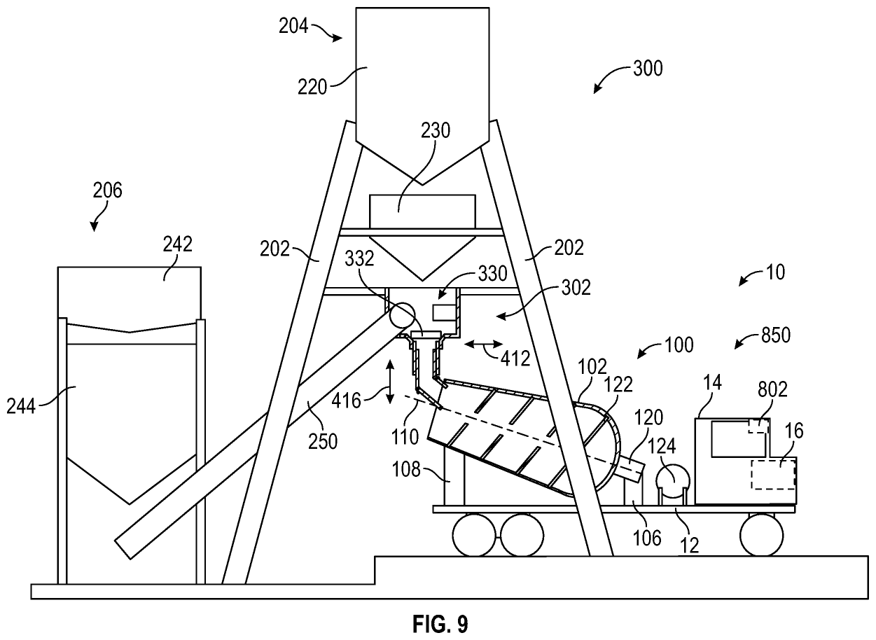

As shown in FIGS. 8-9, a batch plant 300 is shown, according to some embodiments. The batch plant 300 may be similar to or different than the batch plant 200. The batch plant 300 may include some or all of the features of batch plant 200. Likewise, the batch plant 200 may include some or all of the features described with respect to the batch plant 300. Batch plant 300 may include an aggregate supply 206 and a cement supply 204. The aggregate from the aggregate supply 206 may be transported to the concrete mixer truck 10 via a transport mechanism 250. In some embodiments, the transport mechanism 250 includes at least one belt conveyor, screw conveyor, or other material transport mechanism. The aggregate from the aggregate supply 206 and the cement from the cement supply 204 may be directed into a batch plant mixer system 302. In some embodiments, the batch plant mixer system 302 includes some or all of the elements described with respect to the batch plant mixer system 210. In some embodiments, the aggregate from the aggregate supply 206 and/or the cement from the cement supply 204 is transported directly into the concrete mixer truck 10. In such embodiments, the concrete mixer truck 10 may mix and add water to the aggregate, cement, and other materials (e.g., an air-entraining material, a water reducing material, a retarding material, an accelerating material, a plasticizer material, a superplasticizer material, etc.) which may be added separately or simultaneously into the mixing drum 102. The batch plant 300 may include a water supply system for supplying and controlling a supply of water to the concrete mixer truck 10 and/or the batch plant mixer system 210. The water supply system may be automatically operated by a controller using a set of rules, or manually operated by a user (e.g., by manually actuating a valve configured to control a supply of water).

As shown in FIG. 9, the batch plant mixer system 302 includes a batch plant mixer mechanism 330. The batch plant mixer mechanism 330 may include at least one shaft driven by at least one rotational actuator. In some embodiments, the batch plant mixer mechanism 330 may include a container for collecting and temporarily holding material from the batch plant. In some embodiments, the batch plant mixer mechanism 330 may include a pair of shafts with mixing blades extending substantially in a radial direction from each of the shafts. In some embodiments, the batch plant mixer mechanism 330 is or includes at least one of a tilt drum mixer mechanism (e.g., as shown in FIG. 7), a pan mixer mechanism, a planetary mixer mechanism, a single shaft mixer mechanism, or a twin shaft mixer mechanism. The batch plant mixer system 302 may include a batch plant mixer discharge gate system 332. The batch plant mixer discharge gate system 332 may be configured to hold or temporarily store materials in the batch plant mixer mechanism 330 until the materials form a mixture having a predetermined or target mixture parameter or characteristic (e.g., substantially homogenous, homogeneous, a target moisture content, a target slump, etc.). In some embodiments, the batch plant mixer system 302 includes one or more sensors for detecting a characteristic of the mixture contained by the batch plant mixer system 302.

As shown in FIGS. 8-18, the batch plant mixer system 302 includes a mixture output mechanism (e.g., chute assembly, channel, mixture delivery mechanism, mixture trajectory control assembly, mixture trajectory altering assembly, direct charge loading mechanism, direct charge loading assembly, etc.) shown as chute 400. The chute 400 may include some or all the of the features described with respect to the chute 256. In some embodiments, the chute 400 may be configured to facilitate transporting or diverting materials (e.g., mixed materials, partially mixed materials, unmixed materials, wet materials, dry materials, etc.) from the batch plant mixer system 302 into the mixing drum 102 of the concrete mixer truck 10.

As shown in FIGS. 9-14, the chute 400 is selectively movable relative to the frame 202 of the batch plant 300. In some embodiments, chute 400 may be at least partially fixed. As shown, the chute 400 is movable in one or more directions (e.g., a horizontal direction, a vertical direction, a rotational direction, etc.). The chute 400 may be movable in one or more directions relative to frame 202 and/or batch plant mixer mechanism 330. In some embodiments, the chute 400 includes an inlet portion 402, a telescopic portion 404, a swivel chute portion 406, and a chute outlet 408. The inlet portion 402 may couple with the outlet of the batch plant mixer mechanism 330. In some embodiments, the inlet portion 402 includes a collector (e.g., a funnel, a collector assembly, a collector mechanism, etc.) configured to direct material from the outlet of the batch plant mixer mechanism 330 into the downstream portions of the chute 400 (e.g., the telescopic portion 404, swivel chute portion 406, etc.). The inlet portion 402 may be configured to at least partially house a portion of the telescopic portion 404 and/or the swivel chute portion 406.

In some embodiments, the inlet portion 402 is movable in a first plane. In some embodiments, the first plane is substantially horizontal (e.g., substantially parallel to the ground). As shown in FIG. 10, the inlet portion 402 is movable in a first horizontal direction 410 (e.g., along a X-axis, along an axis parallel to the direction of the vectors shown in FIG. 11). As shown in FIG. 11, the inlet portion 402 is movable in a second horizontal direction 412 (e.g., along a Z-axis). In some embodiments, the motion of the inlet portion 402 in the first horizontal direction 410 and the second horizontal direction 412 is controlled by at least one actuator (e.g., linear actuator, rotational actuator, inlet mechanism, etc.), shown as inlet portion actuator 414. The inlet portion actuator 414 may be in communication with a controller. In some embodiments, motion of the inlet portion 402 contributes to or causes a similar motion of the chute outlet 408. For example, inlet portion actuator 414 may cause inlet portion 402 to move an amount (e.g., 1 inch, 1 foot, 1 meter, etc.) in the first horizontal direction 410 relative to the frame 202, and the chute outlet 408 may therefore move an equal or similar amount relative to the frame 202.

In some embodiments, the chute 400 is movable in a second plane. In some embodiments, the second plane is substantially vertical. The telescopic portion 404 may facilitate moving the chute outlet 408 in a vertical or substantially vertical direction, shown as vertical direction 416 (e.g., a Y-axis). In some embodiments, the telescopic portion 404 includes one or more telescoping sections. For example, telescopic portion 404 may include a first telescopic section 420 and a second telescopic section 422. The first telescopic section 420 may be configured to couple (e.g., slidably couple) with the inlet portion 402. In some embodiments, the first telescopic section 420 may be configured to move between a retracted position (e.g., an unextended position, a compact position, etc.) and an extended position. The distance between an end of the inlet portion 402 and an end of the first telescopic section 420 defines a first extension distance 426. In some embodiments, the telescopic portion 404 includes a first telescopic actuator 428 (e.g., linear actuator, hydraulic actuator, etc.) configured to control the position of the first telescopic section 420 relative to the inlet portion 402. In some embodiments, the first telescopic actuator 428 is in communication with a controller.

In some embodiments, the second telescopic section 422 may be configured to couple (e.g., slidably couple) with the first telescopic section 420. In some embodiments, the second telescopic section 422 may be configured to move between a retracted position (e.g., an unextended position, a compact position, etc.) and an extended position. In some embodiments, the distance between a distal end of the first telescopic section 420 and a distal end of the second telescopic section 422 defines a second extension distance 430. In some embodiments, the second extension distance 430 is defined differently (e.g., is defined between a different set of reference points). In some embodiments, the telescopic portion 404 includes a second telescopic actuator 432 (e.g., linear actuator, hydraulic actuator, etc.) configured to control the position of the second telescopic section 422 relative to the first telescopic section 420. In some embodiments, the second telescopic actuator 432 is in communication with a controller. The overall extension distance of the telescopic portion 404 may be defined as a summation of each of the extension distances of each telescopic sections 420, 422. For example, the overall extension distance of the telescopic portion 404 may be defined as the summation of the first extension distance 426 and the second extension distance 430. In some embodiments, each of the sections of the telescopic portion 404 extend along an axis 434. The axis 434 may be a centerline of the flow area through the sections of the telescopic portion 404. As shown, the telescopic sections 420, 422 have circular cross sections, and the axis 434 passes through the center of the telescopic sections 420, 422. In some embodiments, the axis 434 is a centroidal axis of one or more sections of the telescopic portion 404.

In some embodiments, the outlet of the telescopic portion 404 is coupled to the inlet of the swivel chute portion 406. In some embodiments, the telescopic portion 404 may be rotatably coupled to the swivel chute portion 406. The swivel chute portion 406 may include one or more sections. As shown, the swivel chute portion 406 includes a first swivel section 440 and a second swivel section 442. The first swivel section 440 may include a first end 444 and an second end 446. The first end 444 may be an end cut or formed perpendicular to the axis 434. The first end 444 may be configured to couple with the outlet of the telescopic portion 404 to facilitate rotation of the first swivel section 440 about the axis 434. In some embodiments, the first swivel section 440 is configured to rotate about an axis different than axis 434. For example, the first end 444 and the outlet end of the telescopic portion 404 may be formed or fabricated at an angle relative to the axis 434, and the resulting rotational axis of the first swivel section 440 may be different than the axis 434.

In some embodiments, the first swivel section 440 includes an actuator assembly, shown as swivel actuator 448. The swivel actuator 448 may be or include a motor (e.g., direct current (DC) motor, alternating current (AC) motor, hydraulic motor, etc.) configured to drive rotation of the first swivel section 440 about an axis (e.g., axis 434, a central axis, a centroidal axis, a longitudinal axis, etc.). As shown, the swivel actuator 448 is a rotational actuator configured to drive a shaft 450 coupled to an input gear 452. The input gear 452 may engage with and drive a motion of the ring gear 454. The ring gear 454 may be coupled (e.g., welded, bonded, adhered, etc.) to the first swivel section 440 such that a rotation of the input gear 452 drives a rotation of the first swivel section 440 relative to the second telescopic section 422. In some embodiments, the swivel actuator 448 is fixedly coupled to the second telescopic section 422.

In some embodiments, the second swivel section 442 includes a first end 456 and a second end 458. In some embodiments, the first end 456 is rotatably coupled to the second end 446 of the first swivel section 440. In some embodiments, the second swivel section 442 is configured to rotate about an axis (e.g., an axis of rotation), shown as axis 449. In some embodiments, the first end 456 is cut and/or formed at the same angle as the second end 446 of the first swivel section 440 relative to their respective axes of rotation (e.g., axis 434 of the first swivel section 440 and axis 449 of the second swivel section 442). The second end 458 may define the chute outlet 408. For example, materials that enter the chute 400 may flow through one or more sections of the chute 400 (e.g., the first telescopic section 420, the second telescopic section 422, the first swivel section 440, the second swivel section 442) and may ultimately exit the chute 400 via chute outlet 408. In some embodiments, the second end 458 is cut and/or formed at the same or a substantially same or opposite angle relative to the axis of rotation (e.g., axis 449) of the second swivel section 442 as the first end 456. In such embodiments, a plane of the second end 458 which may define the chute outlet 408 is in a substantially vertical plane when the second swivel section 442 is in a first orientation (e.g., an angled discharge orientation, a directed discharge orientation, a side discharge configuration, etc.). In some embodiments, the chute outlet 408 may include additional features (e.g., shields, funnels, screens, channels, grooves, bosses, etc.), and may be shaped differently than shown (e.g., curved) to accommodate different discharge trajectories and different configurations of concrete mixer trucks 10. For example, the chute outlet 408 may be configured to engage with one or more features of the direct charge drum assembly 100 (e.g., a guide, a plate, a groove, a channel, a recess, a boss, etc.) and/or a conventional concrete mixer drum assembly (e.g., a funnel, a charge hopper, etc.).

In some embodiments, the second swivel section 442 includes an actuator assembly, shown as swivel actuator 460. The swivel actuator 460 may be or include a motor configured to drive rotation of the second swivel section 442 about an axis (e.g., axis 449, a central axis, a centroidal axis, a longitudinal axis, etc.). As shown, the swivel actuator 460 is a rotational actuator configured to drive a shaft 462 coupled to an input gear 464. The input gear 464 may be configured to directly or indirectly drive a ring gear 466. The ring gear 466 may be coupled (e.g., welded, bonded, adhered, etc.) to the second swivel section 442 such that a rotation of the input gear 464 drives a rotation of the second swivel section 442 relative to the first swivel section 440. In some embodiments, the swivel actuator 460 may be fixedly coupled to the first swivel section 440.

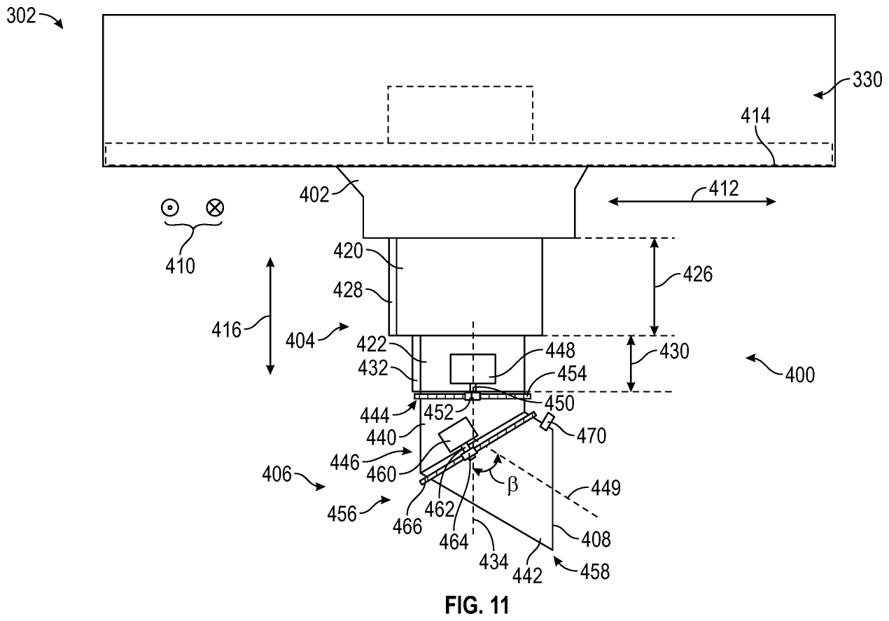

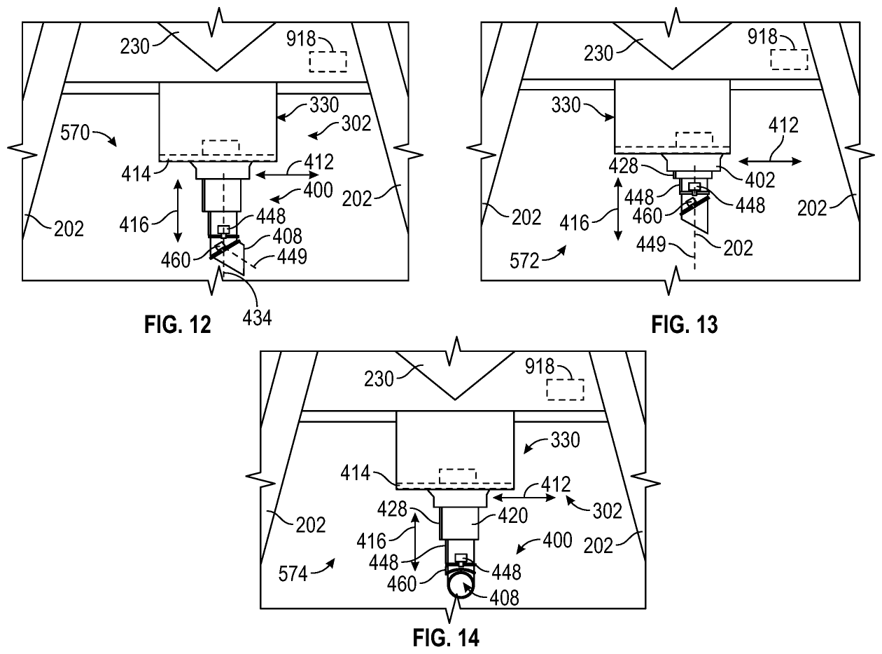

As shown in FIGS. 12, 13, and 14, the chute 400 is selectively movable (e.g., translatable, rotatable, pivotable, etc.) relative to the frame 202. Advantageously, chute 400 may facilitate a user selectively repositioning the chute 400 and thereby chute outlet 408 relative to a mixing drum opening (e.g., mixing drum aperture 104), which may result in an improved mixture delivery and drum charging (e.g., drum loading) user experience. For example, a user may selectively reposition the chute outlet 408 proximate mixing drum aperture 104 to reduce a likelihood of material being misplaced outside of the mixing drum 102 (e.g., splattered, spilled, etc.) of a concrete mixer truck 10. In some embodiments, the chute 400 includes one or more sensors (e.g., laser sensor, camera sensor, radar sensor, ultrasonic sensor, proximity sensor, limit switch, etc.), shown as collision avoidance sensors 470 for detecting and avoiding unexpected contact with the concrete mixer truck 10. For example, the collision avoidance sensor 470 may include a proximity sensor coupled to the chute 400 for determining and monitoring a distance and/or direction of an object, such as the concrete mixer truck 10, relative to the collision avoidance sensor 470. The determined distance and direction of an object (e.g., the concrete mixer truck 10, the mixing drum 102, an emitter, etc.) may be used to avoid collisions between the chute 400 and the object, but may also be used to position the chute 400 relative to the object. In some embodiments, the collision avoidance sensor 470 may be used to determine a position of the object relative to the frame 202. For example, a controller may determine a position and/or orientation of a portion of the concrete mixer truck 10 relative to the frame 202 based on a relationship between the frame 202 and the collision avoidance sensor 470 (e.g., through the position of the chute 400), and relationships between collision avoidance sensor 470 and the object (e.g., a signal representing the direction and distance of the object relative to the collision avoidance sensor 470). In some embodiments, the chute 400 includes one or more sensors (e.g., collision avoidance sensor 470, camera sensor, laser sensor, etc.) coupled to the frame 202. In such embodiments, the position and orientation of at least a portion of the concrete mixer truck 10 relative to the frame 202 can be determined directly using signals from the sensors mounted to the frame 202. In some embodiments, the position and orientation of the concrete mixer truck 10 and the chute 400 is determined relative to a common point or reference point.

The chute 400 may include a liner, sleeve, shield, or other device configured to prevent materials (e.g., cementitious material, aggregate, water, concrete, etc.) from contaminating the moving components of chute 400 and/or interfaces between the moving components of chute 400. For example, a liner may extend from the inlet portion 402 to the chute outlet 408 and/or may prevent cementitious material, aggregate, water, concrete, etc., from interacting with or contaminating the components of the chute 400.

As shown in FIG. 12, the chute 400 is in a first orientation or position, shown as extended side discharge position 570. As shown, the inlet portion 402 is roughly centered below the batch plant mixer mechanism 330, the telescopic portion 404 is in an extended position or orientation, and the swivel chute portion 406 is in an angled discharge (e.g., side discharge) position or orientation.

As shown in FIG. 13, the chute 400 is in a second orientation or position, shown as retracted down discharge position 572. As shown, the inlet portion 402 is not centered below the batch plant mixer system 302, the telescopic portion 404 is in a retracted position or orientation, and the swivel chute portion 406 is in a down discharge position or orientation. In some embodiments, the down discharge position or orientation is a position or orientation in which the passage through the chute 400 is straight or substantially straight and/or the discharged materials pass through the chute outlet 408 in a direction substantially aligned with gravity. By contrast, the angled discharge position or orientation may be a position in which the discharged materials pass through the chute outlet 408 in a direction offset from gravity (e.g., 10 degrees offset, 30 degrees offset, 45 degrees offset, etc.).

As shown in FIG. 14, the chute 400 is in a third orientation or position, shown as extended side discharge position 574. As shown, the inlet portion 402 is roughly centered below the batch plant mixer system 302, the telescopic portion 404 is in an extended position or orientation, and the swivel chute portion 406 is in an angled side discharge position or orientation. In some embodiments, the sections of the swivel chute portion 406 may be circular.

As shown in FIGS. 8-14, the chute 400 has at least one degree of freedom. For example, the inlet portion 402 may have two degrees of freedom (e.g., translational motion in the first horizontal direction 410, and translational motion in the second horizontal direction 412). The first telescopic section 420 and the second telescopic section 422 may each have one degree of freedom (e.g., translational motion in the second horizontal direction 412). The first swivel section 440 may have one degree of freedom (e.g., rotational motion about axis 434). The second swivel section 442 may have one degree of freedom (e.g., rotational motion about axis 449). As shown, each degree of freedom is controllable. In some embodiments, the chute 400 is holonomic. The actuators and actuator assemblies of the chute 400 may selectively move (e.g., translate, rotate, etc.) the components of the chute 400 based on a user input. For example, the actuators and actuator assemblies of the chute 400 may be configured to selectively move the chute 400 between the positions 570, 572, 574, and any other suitable position defined by the degrees of freedom of the chute 400. The available positions and orientations of the chute 400 relative to the frame 202 or another reference may define a operational envelope (e.g., operational range, operational domain, etc.) of the chute 400, which may be used to determine whether a direct charge drum assembly 100 is compatible with a chute 400.

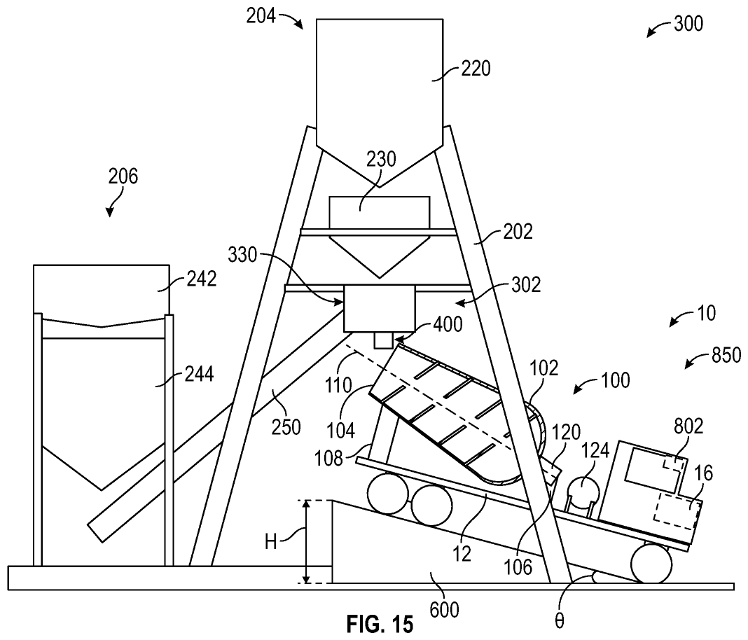

As shown in FIG. 15, the batch plant 300 includes a support (e.g., a platform, a vehicle support, etc.), shown as ramp 600, which may support a concrete mixer truck 10 during a direct charge operation. For example, the ramp 600 may include a sensor (e.g., weight sensor, etc.) for detecting a presence of a concrete mixer truck 10. In some embodiments, ramp 600 is configured to manipulate the position or orientation of the concrete mixer truck 10. For example, a slope of the ramp 600 may cause a position or orientation of axis 110 of a concrete mixer truck 10 on the ramp 600 to be more similar to a position or orientation of an axis of the chute 400 (e.g., axis 449). In such example, the more similar position or orientation may facilitate a larger flow area (e.g., an area of mixing drum aperture 104) perpendicular to the flow of material as material exits the chute 400 and enters the mixing drum 102. The position and orientation of ramp 600 may be fixed, or may be selectively adjustable by one or more actuators. For example, the ramp 600 may be configured to adjust a slope, curve, height, shape, position, or other characteristic of the ramp 600 to facilitate an a direct charge operation of the concrete mixer truck 10. The ramp 600 may be actuated and positioned to supplement movements of the chute 400 to accommodate the concrete mixer truck 10.

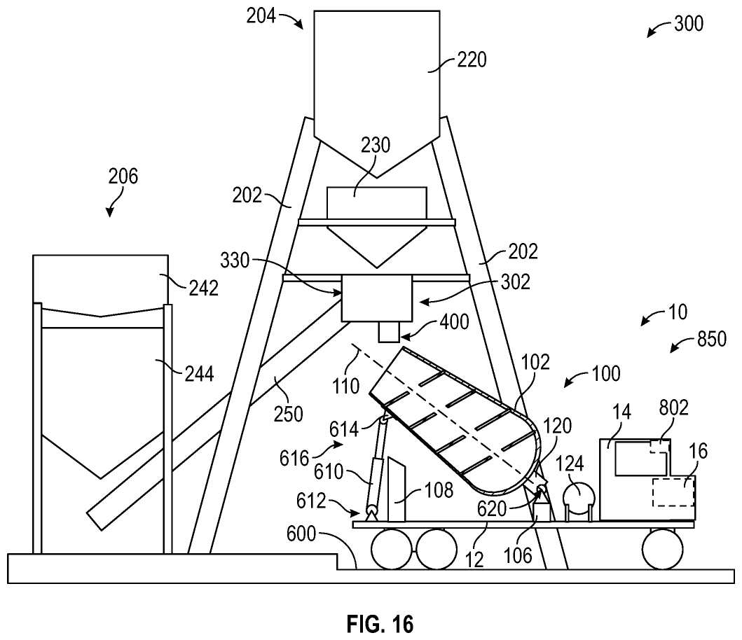

As shown in FIG. 16, the concrete mixer truck 10 includes an drum repositioning device (e.g., hydraulic actuator, actuated mechanism, electronic actuator, etc.) shown as actuator 610. The actuator 610 may selectively raise or lower a portion of the mixing drum 102 in response to a control signal. The actuator 610 may be configured to selectively manipulate the position of the axis 110. The actuator 610 may be supportively coupled to the mixing drum 102 proximate the end of the mixing drum 102 defining the mixing drum aperture 104. For example, the actuator 610 may be or include one or more actuators coupled to a portion of the frame 12 at a first end 612, and may be coupled to a supporting member (e.g., plate, ring, arcuate member, etc.), shown as drum support 614, at a second end 616. The drum support 614 may be configured to support the mixing drum 102 and facilitate motion of the mixing drum 102 relative to the frame 12. For example, the drum support 614 may include one or more bearings to facilitate a rotation of the drum about axis 110 while the actuator 610 is supporting the mixing drum 102. In some embodiments, the rear pedestal 108 is configured to support the mixing drum 102 during transit, and the actuator 610 is configured to engage with and support the mixing drum 102 during a drum charging operation (e.g., loading operation). In some embodiments, the rear pedestal 108 is or includes the actuator 610. As shown, the front pedestal 106 may include a pivot 620 about which the mixing drum 102 may pivot. For example, as the actuator 610 selectively raises or lowers the loading end of the mixing drum 102 (e.g., the end defining the mixing drum aperture 104), the mixing drum 102 and/or drum motor 120 may pivot about pivot 620. In such embodiments, the mixing drum 102 is selectively rotatable about axis 110 when the actuator 610 is supporting the mixing drum 102. Such rotation of the mixing drum 102 may facilitate charging the mixing drum 102 with material and/or mixing the material during charging.

In some embodiments, the actuator 610 may be configured to manipulate the angular position of the axis 110 such that the axis 110 is up to 90 degrees offset from a horizontal plane of the frame 12. In other words, the actuator 610 may raise or lower the axis 110 such that the mixing drum 102 is substantially vertical or perpendicular to the frame 12. In some embodiments, the actuator 610 is configured to adjust the angular position of the axis 110 between a transit position (e.g., an operating position, a lowered position, etc.) and a charging positon (e.g., a loading position, a mixing position, a raised position, etc.). In some embodiments, the transit position is an angle between 5 degrees and 45 degrees, and the charging position is an angle between 45 degrees and 90 degrees. In other embodiments, the transit position is an angle between 5 degrees and 20 degrees, and the charging position is between 20 degrees and 90 degrees. In some embodiments, manipulating the angular position of axis 110 may provide an operator with additional control over the a characteristic of the mixing achieved within the mixing drum 102. For example, more or less air may be entrained into the mixture based on the angular position of axis 110 and the shape and position of the mixing elements 122 within the mixing drum 102.

As shown in FIGS. 6 and 17, the concrete mixer truck 10 may facilitate removably coupling a hopper 150 thereto. An operator may position the hopper 150 below chute 400 to selectively collect and/or direct a material discharged from the chute 400 into the mixing drum aperture 104. The hopper 150 may be selectively removable to reduce the overall weight of the concrete mixer truck 10 when uninstalled from the concrete mixer truck 10. A reduced weight of the concrete mixer truck 10 may improve the fuel efficiency of the concrete mixer truck 10 and facilitate a larger legal payload of the concrete mixer truck 10. In some embodiments, the hopper 150 may be used with a batch plant having a chute 400. In other embodiments, the hopper 150 may be used with a batch plant 300 having a fixed chute (e.g., a chute that does not articulate or move relative to the batch plant 300, a chute that is not selectively repositionable, etc.). For example, a batch plant 300 may have a chute 400 having only one position corresponding to a fixed trajectory of material relative to the frame 202. In such example, the hopper 150 may facilitate directing materials discharged from the chute 400 into the mixing drum 102.

In some embodiments, the batch plant 300 is configured to load a direct charge drum assembly 100. In yet another example, the direct charge drum assembly 100 is configured to receive materials from the batch plant 300. For example, the concrete mixer truck 10 may have an actuator 610 and/or features supportive of the hopper 150 (e.g., the mounting apertures 146). In another example, the batch plant 300 may include the ramp 600 and/or the chute 400. The features of the batch plant 300 may compliment or accommodate the features of the concrete mixer truck 10, and vice versa. For example, a batch plant 300 including a ramp 600 and/or a chute 400 may facilitate charging a concrete mixer truck 10 having one or more of the actuator 610 and features supportive of hopper 150. In another example, a concrete mixer truck 10 including the actuator 610 and/or the hopper 150 may facilitate loading the concrete mixer truck 10 via a batch plant 300 having none of the ramp 600 and the chute 400, or one or more of the ramp 600 and/or the chute 400.

In some embodiments, the chute 400 may include more or fewer telescopic portions 404 and/or swivel chute portions 406 than shown, and the components of the chute 400 may be in a different arrangement. In some embodiments, chute 400 includes one or more telescopic portion 404 and swivel chute portion 406. For example, a second telescopic section 422 may be downstream from the swivel chute portion 406 to support a telescopic motion downstream the swivel chute portion 406. The chute 400 may include a first telescopic section 420 coupled to and upstream the swivel chute portion 406 and a second telescopic section 422 coupled to and downstream the swivel chute portion 406. Each of the telescopic portion 404 and the swivel chute portion 406 may include more or fewer sections than shown. For example, the swivel chute portion 406 and telescopic portion 404 may include three, four, five, etc., sections. Each of the sections of the telescopic portion 404 and the swivel chute portion 406 may be shaped differently than shown. For example, the swivel chute portion 406 may include curved sections, and/or the ends of the sections may be cut or shaped differently than shown. The chute 400 may include more or fewer controllable degrees of freedom. For example, the chute inlet portion 402 may include structures and actuators supportive of roll, pitch, yaw, and translational motions. The chute 400 may include a different angular adjustment mechanism and may not include the swivel chute portion 406. For example, the chute 400 may include a pivotable section (e.g., hinged section, etc.) that is configured to adjust a trajectory of material through the chute 400 (e.g., the angle, B, formed between the axis 434 and the axis 449).

### Auxiliary Fluid System

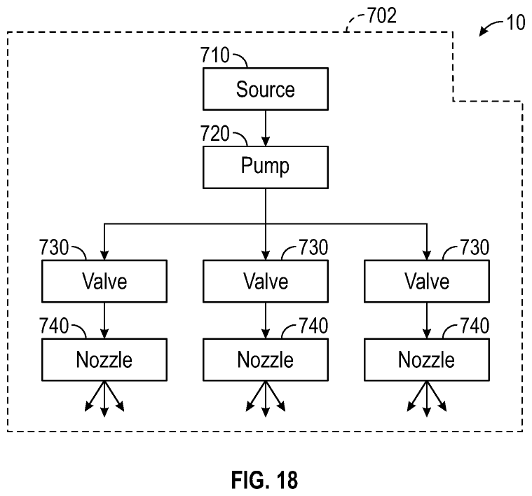

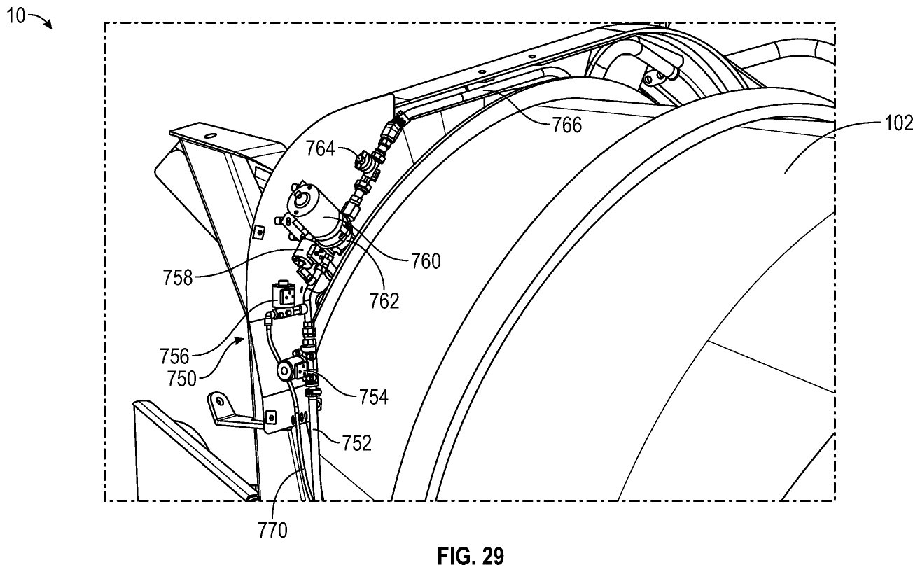

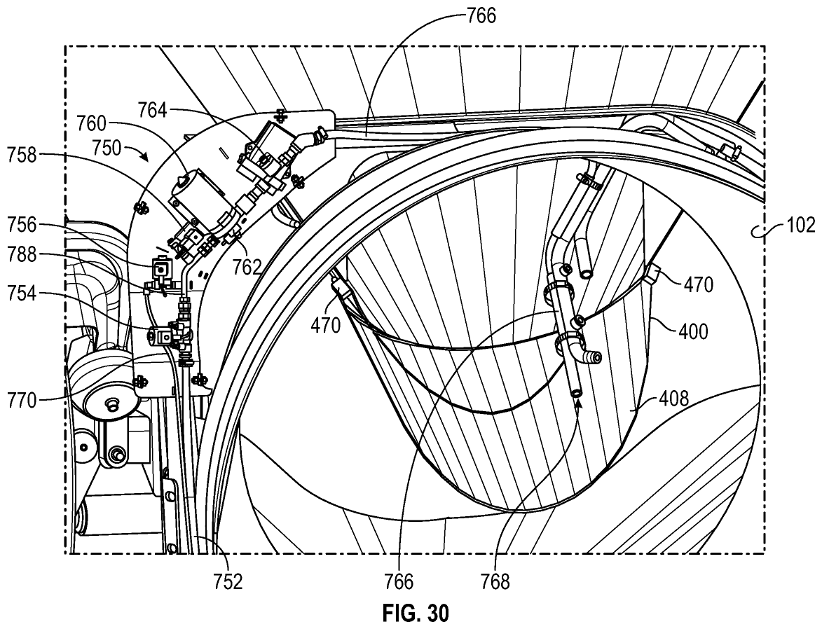

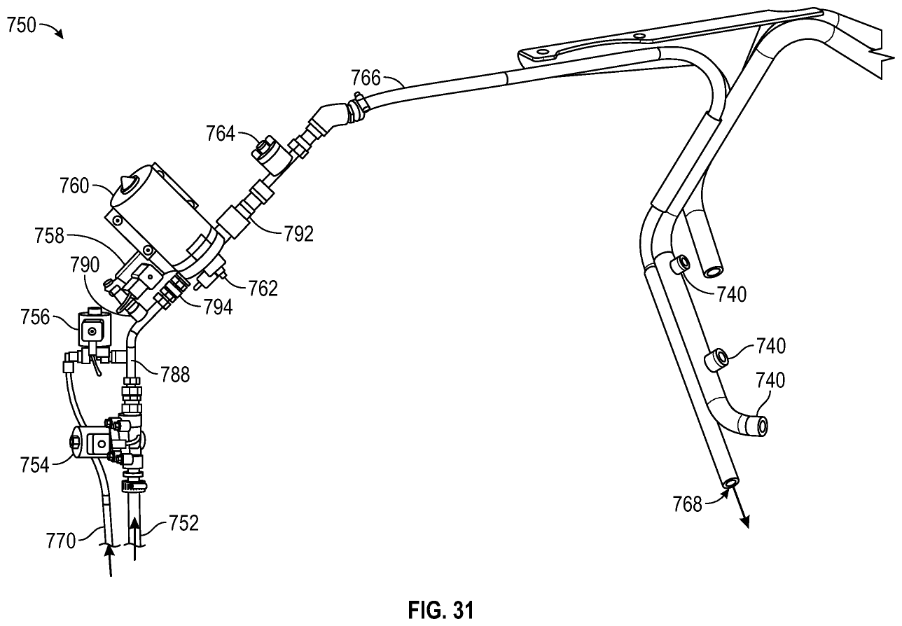

As shown in FIGS. 18-33, the concrete mixer truck 10 includes a system, shown as auxiliary fluid system 700. The auxiliary fluid system 700 may have one or more subsystems. For example the auxiliary fluid system 700 may include a cleaning system (e.g., a wash fluid system, a washout fluid system, a cleaning fluid system, etc.) shown as wash system 702. The wash system 702 may be used to wash at least one component or target of the concrete mixer truck 10. For example, the wash system 702 may include a reservoir (e.g., tank, container, compartment, etc.) for storing wash fluid (e.g., detergent, water, acid wash, treated water, heated water, etc.). The reservoir may be fluidly connected to a pressure generating device (e.g., a pump) configured to supply the wash fluid to a water outlet device (e.g., a hose, a nozzle, etc.). The one or more outlet devices may be positioned and arranged to direct fluid (e.g., wash fluid, admixture material, water, etc.) onto or into a target of the concrete mixer truck 10. For example, the wash system 702 may supply wash fluid to dislodge, dilute, and/or dissolve residual material (e.g., wet concrete, aggregate, material, cured concrete, etc.) on or within the target. The targets may be or include an interior of the mixing drum 102, an exterior of the mixing drum 102, the collector 134, and/or the chute assembly 132. The auxiliary fluid system 700 may include one or more electronically and/or manually controllable valves fluidly coupled to one or more outlet devices (e.g., nozzles) which may selectively control (e.g., inhibit, facilitate, regulate, divert, etc.) wash fluid to one or more of the outlet devices. For example, a first valve may have a first valve position associated with a first set of one or more outlet devices and a second valve position associated with a second set of one or more outlet devices. The wash system 702 is discussed in detail below.

In some embodiments, the auxiliary fluid system 700 includes a system, shown as admixture system 750. The admixture system 750 may be independent from other systems of the auxiliary fluid system 700. For example, the admixture system 750 may be fluidly separate (e.g., not sharing a fluid conduit or a fluid path prior to discharge to the mixing drum 102) from the wash system 702. The admixture system 750 may be configured to add an admixture material and/or other additives to the mixing drum 102. For example, the admixture system 750 may contain one or more reservoirs for containing one or more admixture materials. In some embodiments, the additive of the admixture system 750 may be or include an air-entraining admixture (e.g., a synthetic resin, an acid salt, a detergent, etc.), a water-reducing admixture (e.g., a salt, an acid, a lignin acid, a polymeric material, etc.), a retarding admixture, an accelerating admixture, a bonding admixture, a coloring agent, a waterproofing admixture, a plasticizer, a super-plasticizer, a coloring agent, or any other admixture material and additive. In some embodiments, the admixture material is supplied or/or stored in one or more admixture reservoirs in a liquid form and the liquid form of the admixture is pumped into the mixing drum 102 by one or more pumps. In other embodiments, the admixture material is supplied by the admixture reservoirs as a solid (e.g., a powder) and is added to the drum as a solid. For example, a solid admixture material may be inserted into the mixing drum 102 in a powdered form via a delivery system such as a screw mechanism and/or a belt mechanism. In other embodiments, a powdered form of admixture material may be integrated into (e.g., mixed with, dissolved into, suspended by, etc.) a stream of fluid upstream one or more outlet devices associated with the mixing drum 102. In such embodiments, the admixture material may be transported into the mixing drum 102 by the flow of the fluid stream. The admixture system 750 is described in more detail below.

In some embodiments, the auxiliary fluid system 700 includes a system, shown as water add system 799. The water add system 799 may be configured to supply water to the interior of the mixing drum 102. For example, the water add system 799 may include a supply of water (e.g., a water reservoir) fluidly connected to a pump and one or more fluid outlet devices (e.g., nozzles 740). The water add system 799 may be an independent system (e.g., a stand-alone system) of the auxiliary fluid system 700.

In some embodiments, the water add system 799 may support the wash system 702 and/or the admixture system 750. By way of example, the water add system 799 may support the wash system 702 by providing a flow of fluid to a target during a cleaning operation (e.g., the interior of the mixing drum 102). By way of another example, the water add system 799 may support the admixture system by providing a flow of fluid for integration with and delivery of admixture material to the mixing drum 102. In some embodiments, the water add system 799 is independent of the wash system 702 and/or the admixture system 750. In such embodiments, the fluid path of the water add-system may be free of contaminants associated with the wash system 702 (e.g., residual admixture material and/or residual cleaning fluid and/or cleaning additives) which may facilitate an accurate composition of a mixture within the mixing drum 102. In some embodiments, the auxiliary fluid system 700 includes one or more reservoirs for each system of the auxiliary fluid system. For example, the auxiliary fluid system 700 may include one water tank, one washout system tank, and one admixture tank), and each of the systems (e.g., the wash system 702, the admixture system 750, and the water add system 799 share or have a dedicated pump (e.g., pump 720), fluid control device (e.g., valve 730 or set of valves 730), and dedicated outlet device (e.g., nozzle 740).

In some embodiments, the water add system 799 is integrated into the wash system 702. The water add system 799 may be integrated into the wash system 702 when one or more components of the wash system 702 are shared by the wash system 702. By way of example, the water add system 799 may be integrated into the wash system 702 when the wash system 702 includes a water reservoir fluidly connected to a pump and an outlet device associated with the interior of the mixing drum 102 that is configured to selectively supply water from the reservoir to the interior of the mixing drum 102.

In some embodiments, one or more systems of the auxiliary fluid system 700 is integrated into another system of the auxiliary fluid system 700. By way of example, the water add system 799 may be partially integrated into the wash system 702. The reservoir of the wash system 702 may be filled with water, and a treatment (e.g., additive, etc.) may be selectively integrated into a stream of water downstream the reservoir (e.g., via a mixing device selectively supplied by a reservoir of treatment and associated with the stream of water) to facilitate delivering water to the mixing drum 102 and a cleaning solution to a target of the concrete mixer truck 10. In some embodiments, the auxiliary fluid system 700 may include a first reservoir for storing a cleaning mixture (e.g., a cleaning solution) to support cleaning operations, and a second reservoir for storing water to support water add operations. In this way, the wash system 702 may be configured to selectively supply water to the mixing drum 102 to adjust a characteristic of a mixture within the mixing drum 102 (e.g., a slump of concrete) during a first mode of operation (e.g., a drum charging operation, a mixing operation, etc.), and also supply a cleaning mixture to the mixing drum 102 and/or another suitable target location during a second mode of operation (e.g., a cleaning operation). Integrating one or more systems of the auxiliary fluid system 700 (e.g., the water add system 799 and/or the admixture system 750) into another system of the auxiliary fluid system 700 (e.g., the wash system 702) can facilitate a reduced overall system complexity, maintenance requirement, and weight of the auxiliary fluid system 700. A reduced weight of the auxiliary fluid system 700 may facilitate a higher legal payload weight of the concrete mixer truck 10.

A controller may selectively control a system or subsystem of the auxiliary fluid system 700. For example, a controller may control an actuator associated with a component of the system (e.g., a valve, motor, pump, etc.) by adjusting a setpoint or operational parameter (e.g., a duty cycle, a position, a voltage, etc.) of the component. For example, a controller may control a valve between a first valve position and a second valve position (and/or a third position, fourth position, etc.) to control the discharge of material (e.g., fluid, admixture material, water, wash fluid, etc.) from one or more outlet devices associated with a first set and/or a second set of outlet devices. It is important to note that the auxiliary fluid system 700 may include a plurality of valves, pumps, sensors, actuators, and other control devices configured to divert, inhibit, regulate, check, or otherwise control a discharge of material at a plurality of outlet devices. The auxiliary fluid system 700 may be automatically operated (e.g., electronically controlled, electronically triggered, remotely activated, etc.), manually operated (e.g., using direct user input to actuate a valve, or switch), or a combination thereof (e.g., partially manually operated, partially automatically operated, etc.). By way of example, a wash system 702 may be an automatic wash system if the system is electronically controlled, electronically triggered, remotely activated, or otherwise controlled using a command or signal associated with an electronic circuit. By way of another example, a wash system 702 may be a manual wash system if the system is controlled by a user actuating a mechanical control device (e.g., a valve, switch, a lever, a cable system, etc.) of the wash system. For example, a user may utilize a manual wash system by manually actuating mechanical components of the system (e.g., a fluid control device, a valve, switch, etc.). In some embodiments, at least a portion of the auxiliary fluid system 700 is automatically operated and another portion of the auxiliary fluid system 700 is manually operated. For example, the wash system 702 or a portion of the wash system 702 may be manually operated and a portion of the admixture system 704 may be controlled automatically based on control logic of a controller. In some embodiments, the auxiliary fluid system 700 is configured to operate based on a user input and/or a local or remote control signal generated by a controller.

### Washout System

As discussed above, the auxiliary fluid system 700 may include a wash system 702. As shown in FIG. 18, the wash system 702 facilitates cleaning of a target of the concrete mixer truck 10 (e.g., the mixing drum 102, the mixing element 122, the collector 134, the chute assembly 132, etc.). The wash system 702 includes a reservoir (e.g., tank, etc.), shown as source 710, and a pump, shown as pump 720. The source 710 is configured to store a fluid (e.g., water, non-potable water, treated water, etc.) and the pump 720 is configured to draw the fluid from the source 710. The source 710 may be, for example, a one-hundred gallon water tank. However, the source 710 may also have other similar capacities (e.g., sixty-five gallons, ninety gallons, one-hundred and twenty-five gallons, one-hundred and fifty gallons, two-hundred gallons, two-hundred and fifty gallons, three-hundred gallons, three-hundred and eighty-five gallons, etc.). In some embodiments, the source 710 is the same as or similar to the fluid tank 124. The source 710 may be fluidly coupled to the pump 720. The source 710 may be configured to selectively dose the fluid with a cleaning agent to facilitate accelerated cleaning of a target.

The wash system 702 also includes a plurality of valves (e.g., solenoids, electronic valves, electronic ball valves, electromagnetic valves, etc.), shown as electronically controllable valves 730, and a plurality of nozzles (e.g., sprayers, heads, slurry nozzles, etc.), shown as nozzles 740. The electronically controllable valves 730 are each fluidly coupled to the pump 720, such that fluid can be drawn from the source 710 by the pump 720 and provided to the electronically controllable valves 730. The pump 720, the electronically controllable valves 730, and the nozzles 740 are connected through the use of various fluid conduits (e.g., hoses, pipes, fittings, etc.). The electronically controllable valves 730 may each selectively provide the fluid to one or more of the nozzles 740. For example, some of the electronically controllable valves 730 may provide the fluid to two or more nozzles 740 while others of the electronically controllable valves 730 each provide the fluid to one nozzle 740. In one embodiment, the number of electronically controllable valves 730 is equal to the number of nozzles 740.

The nozzles 740 are each defined by a target that is provided fluid when the nozzle 740 receives fluid from the corresponding electronically controllable valve 730. The targets of the nozzles 740 may be, for example, the mixing drum 102 (e.g., the front of the mixing drum 102, the rear of the mixing drum 102, the outside of mixing drum 102, the inside surface of the mixing drum 102, etc.), the mixing element 122 (e.g., the edges of the mixing element 122, the center of the mixing element 122, etc.), the collector 134 (e.g., an inlet of the collector 134, an outlet of the collector 134, an interior surface of the collector 134, an exterior surface of the collector 134, etc.), and the chute assembly 132 (e.g., an inlet of the chute assembly 132, an outlet of the chute assembly 132, an interior surface of the chute assembly 132, etc.). Each nozzle 740 may have a different target, or multiple nozzles 740 may have the same target. The nozzles 740 may be automatically or manually adjustable such that the target of each of the nozzles 740 may be tailored for a target application of the concrete mixer truck 10.

The nozzles 740 function to remove solids (e.g., wet cement, dried cement, slurry, debris, deposits, etc.) from the targets, thereby cleaning the targets. By cleaning the targets, the wash system 702 increases the longevity (e.g., service life, etc.) and desirability of the targets. In some applications, cleaning of the targets may be required by customer demands, regulatory requirements, industry standards, or other similar requirements. After the fluid is discharged by the nozzle 740 towards the target, the fluid may flow, for example, into the mixing drum 102 and/or onto the ground (e.g., outside of the concrete mixer truck 10, etc.).

In one example, a nozzle 740 is positioned within the collector 134. When fluid is provided through this nozzle 740, the fluid may wash solids off of the collector 134. The combination of the fluid and the solids washed from the collector 134 may be discharged onto the ground (e.g., outside of the concrete mixer truck 10, etc.). In yet another example, a nozzle 740 is positioned within the chute assembly 132. When fluid is provided through this nozzle 740, the fluid may wash solids off of the chute assembly 132. The combination of the fluid and the solids washed from the chute assembly 132 may also be discharged onto the ground (e.g., outside of the concrete mixer truck 10, etc.). In an alternative embodiment, the concrete mixer truck 10 includes a catch (e.g., gutter, reservoir, etc.) configured to collect fluid and solids discharged from the collector 134 and/or the chute assembly 132. In this embodiment, the catch may substantially prevent fluid and solids from being discharged onto the ground.

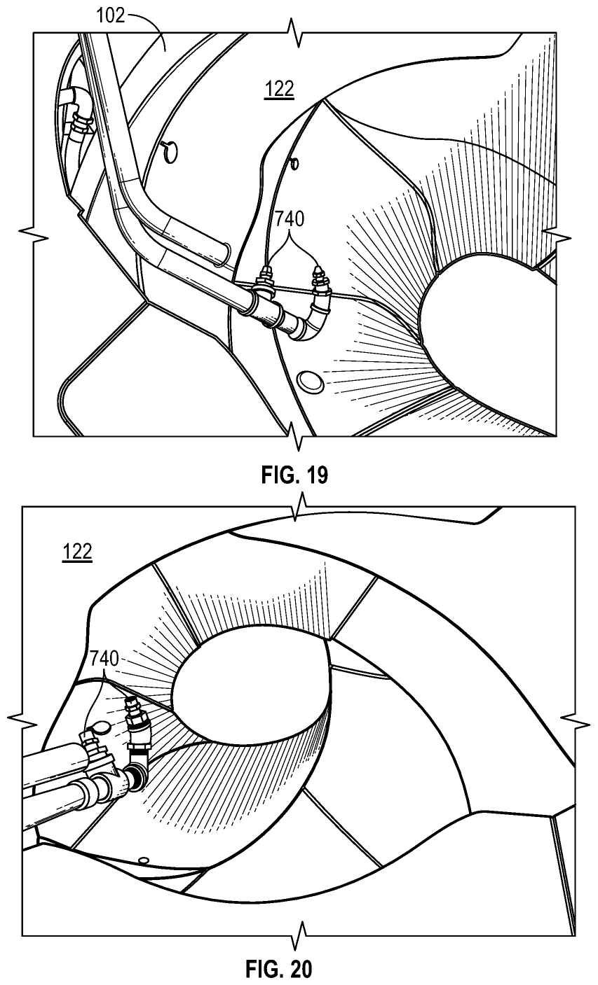

FIGS. 19-27 illustrate the concrete mixer truck 10 in detail according to various embodiments. According to one embodiment, the nozzles 740 are positioned in series along the same fluid conduit and thereby connected to the same electronically controllable valve 730. In other embodiments, at least some of the nozzles 740 are connected to different fluid conduits and thereby may be connected to different electronically controllable valves 730.

As shown in FIGS. 19 and 20, the concrete mixer truck 10 includes two nozzles 740 mounted within the mixing drum 102. The nozzles 740 extend into the mixing drum 102 and may be oriented to direct fluid towards an inner surface of the mixing drum 102 and/or the mixing element 122. The nozzles 740 may function to dislodge solids from the inner surface of the mixing drum 102 and/or from the mixing element 122. In these applications, the combination of fluid and solids may be retained within the mixing drum 102. The nozzles 740 may also function to add water to the mixing drum 102 to change the slump of concrete within the mixing drum 102. For example, the auxiliary fluid system 700 may add water from a source (e.g., source 710) to the mixing drum 102 by selectively pumping the water from the source through the nozzles 740. The nozzles 740 may also function to add an admixture material to the mixing drum 102 to change a characteristic or property of concrete within the mixing drum 102. In some embodiments, the nozzles 740 are selectively connected with at least one of a group of multiple sources (e.g., source 710, a water source, an admixture source, a cleaning fluid source).

As shown in FIGS. 21 and 23-25, the concrete mixer truck 10 includes multiple nozzles 740 mounted near the opening of the mixing drum (e.g., mixing drum aperture 104) and the collector 134 and the chute 400 of the batch plant 300 is in a charging position where the chute 400 is configured to direct material directly into the mixing drum 102 to thereby directly charge the mixing drum 102 with material. These nozzles 740 may be mounted on a common mounting plate. These nozzles 740 may be oriented towards any of the mixing drum 102, the mixing element 122, the collector 134, and the chute assembly 132. For example, some of the nozzles 740 may be oriented towards the collector 134 such that solids on or within the collector 134 can be dislodged by the fluid. At least a portion of the combination of fluid and solids that flows from the collector 134 can flow through an aperture of the collector 134, into the chute assembly 132, and discharged onto the ground. As shown in FIG. 16, the nozzles 740 may each be oriented at different targets. For example, some of the nozzles 740 may be oriented towards the chute assembly 132 such that solids on or within the chute assembly 132 can be dislodged by the fluid. Similarly, some of the nozzles 740 may be oriented towards an outside surface of the mixing drum 102 such that solids along the outside surface of the mixing drum 102 can be dislodged by the fluid. Some of the nozzles 740 may be oriented towards an outside surface of the collector 134 such that solids along the outside surface of the collector 134 can be dislodged by the fluid. In some embodiments, some of the nozzles 740 may be oriented toward a portion of the direct charge drum assembly 100 that is used to position a chute (e.g., the chute 400) of a batch plant (e.g., the batch plant 300) relative to the mixing drum 102. For example, some nozzles 740 may be directed toward a groove, channel, sensor, camera, visual indicator, magnet, emitter, receiver, and/or other features that may be used to position the chute 400 in a charging position relative to the mixing drum 102.

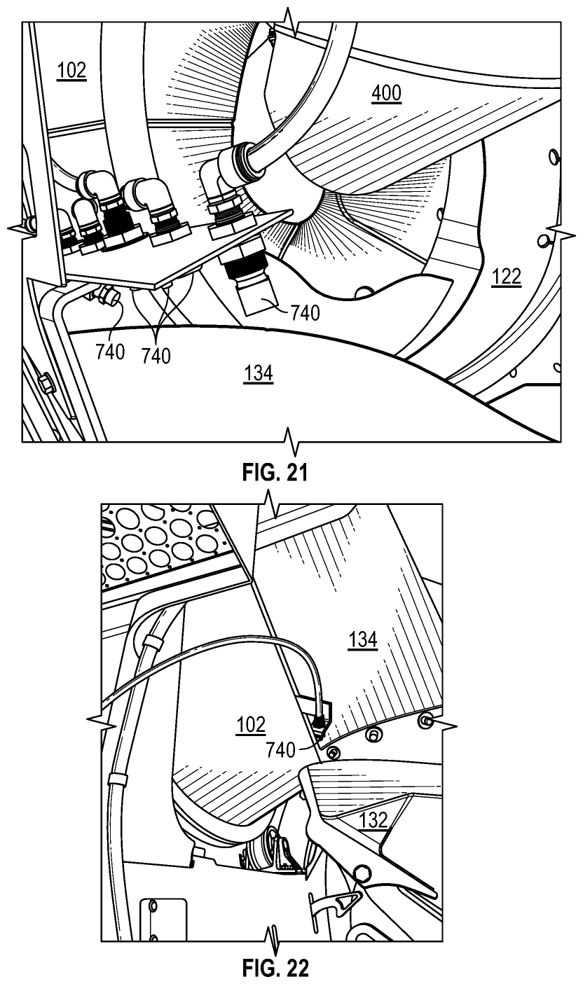

As shown in FIG. 22, the concrete mixer truck 10 includes a nozzle 740 mounted underneath the collector 134. This nozzle 740 may be oriented towards a gap between the collector 134 and the chute assembly 132. This nozzle 740 may direct fluid into this gap such that solids within the gap are dislodged by the fluid. Similarly, a nozzle 740 may be oriented towards a junction between the mixing drum 102 and the collector 134.

As shown in FIGS. 21 and 23, the chute 400 is positioned in a direct charge position, according to some embodiments. The position of the nozzles 740 and the fluid conduits connecting nozzles 740 may be positioned around or away from the mixing drum aperture 104 such that the nozzles 740 do not obstruct the chute 400 during a charging operation of the mixing drum 102 using a chute 400.

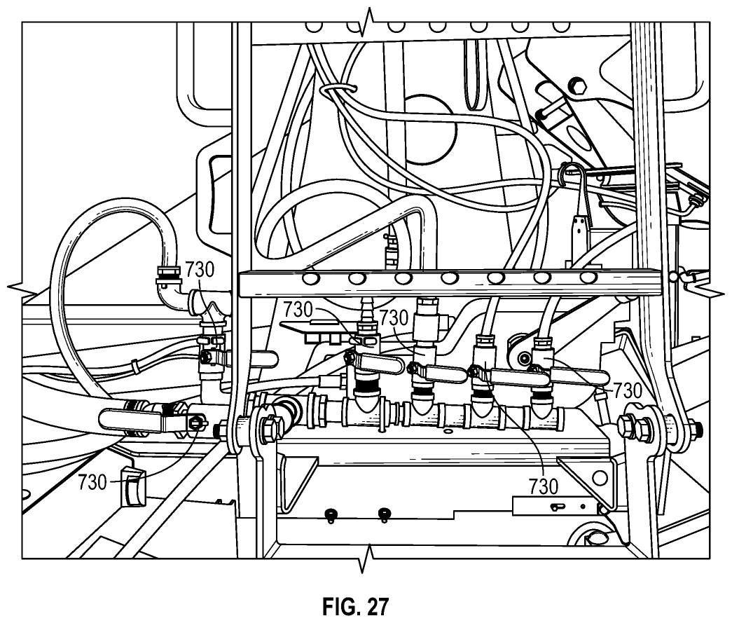

As shown in FIGS. 26 and 27 the electronically controllable valves 730 may be connected to a main header in parallel. In some embodiments, all of the electronically controllable valves 730 are two-way valves. However, some or all of the electronically controllable valves 730 may also be three-way valves, or any other similar valve. The electronically controllable valves 730 may include a manual override, an emergency stop, a testing function, a maintenance function, a flow meter, a position sensor, a diagnostic function, or other similar features.

### Admixture System

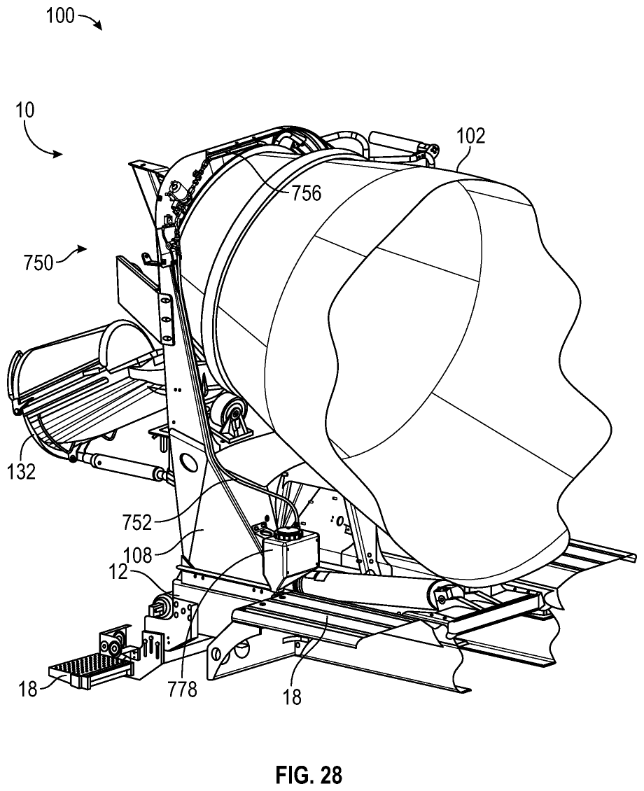

As shown in FIGS. 28-31, the admixture system 750 is shown in greater detail, according to an exemplary embodiment. The admixture system 750 may be configured to use compressed air to clear one or more lines, conduits, tubular members, etc., when additive is added to the mixing drum 102. As shown in FIGS. 28-31, the admixture system 750 includes a reservoir (e.g., tank, container, etc.) that stores additive (e.g., admixture material) for the mixing drum 102, a compressed air system, a valve, an air valve, an air inlet valve, a pump, a check valve, a flow meter, and an outlet pipe that is configured to discharge additive, fluid, or air into the mixer drum. As shown in FIGS. 28-30, the admixture system 750 may extend along a side of the mixing drum 102 and can include an outlet line 766 (e.g., a conduit, a tubular member, a hose, piping, etc.) that extends into the mixing drum 102. The outlet line 766 may extend into the mixing drum 102 along the top of the mixing drum 102 so that additive, fluid, air, gas, etc., that is transferred through the outlet line 766 enters the mixing drum 102 and minimizes blocking the mixing drum aperture 104. The outlet line 766 includes an opening, a window, an aperture, a hole, etc., shown as outlet opening 768, through which fluid, liquid, additive, air, gas, etc., exits.

As shown in FIGS. 28-31, admixture system 750 includes a first inlet conduit, tubular member, hollow member, pipe, hose, line, etc., shown as first inlet line 752 and a second inlet conduit, tubular member, hollow member, pipe, hose, line, etc., shown as second inlet line 770. The admixture system 750 also includes a valve 754 (e.g., a fluid valve), an air valve 756, an air inlet valve 758, a pump 760, a check valve 762, and a meter 764.

The valve 754 may be fluidly coupled in-line with first inlet line 752 and can be transitionable between an open position and a closed position to allow or restrict flow through first inlet line 752. The first inlet line 752 can fluidly couple with a tank, a container, a reservoir, etc., shown as tank 778. The valve 754 may be an electronic valve that is electrically controllable or operable by a controller, processing device, control system, etc. In some embodiments, the valve 754 is normally in the open position so that pump 760 can operate to draw fluid from tank 778.

The air valve 756 can be similar to valve 754. For example, the air valve 756 may be an electronic valve that is controllable by a controller, processing device, control system, etc. The air valve 756 is fluidly coupled in-line with the second inlet line 770 and may be transitionable between an open position and a closed position to allow or restrict flow of air through the second inlet line 770. In some embodiments, the air valve 756 is operated so that fluid may be driven into mixing drum 102 when air valve 756 is transitioned into the closed position. The air valve 756 may transition into the closed position and maintain the closed position as fluid is driven from the tank 778 to the mixing drum 102 by the pump 760.

The pump 760 may be an electric pump. For example, the pump 760 can be a 12-volt suction or discharge pump that may be controllable or operable by a controller, a processing device, a control system, etc. In some embodiments, the pump 760 is a variable displacement pump so that a flow rate of fluid drawn from the tank 778 and discharged into the mixing drum 102 can be adjusted or controlled. The pump 760 may draw electrical energy from an energy storage system of the concrete mixer truck 10. The concrete mixer truck 10 can include one or more battery cells, electrical energy storage devices, capacitors, an energy storage system, etc., configured to store electrical energy that can be used (e.g., by a control system) to operate the pump 760.

The meter 764 can be positioned downstream from the pump 760 (e.g., downstream from the pump 760 but upstream from the outlet line 766) so that the meter 764 measures a flow rate, volume, mass, speed, etc., of fluid discharged by the pump 760. In other embodiments, the meter 764 is positioned upstream from the pump 760 (e.g., on a suction side of the pump 760) between the pump 760 and the tank 778. The meter 764 can obtain any of the flow rate, volume, mass, speed, etc., of fluid discharged by the pump 760 or suctioned from the tank 778 by the pump 760 as meter information and may provide the meter information to a controller or control system of concrete mixer truck 10.

The check valve 762 can be fluidly coupled in-line with the pump 760 (e.g., on the suction side of the pump 760 or on a discharge side of the pump 760) to prevent fluid downstream from the pump 760 from draining back into the tank 778 (e.g., when the air inlet valve 758 and the valve 754 are in the open position). The check valve 762 can be a swing, lift (e.g., a piston or ball), stop, or tilting-disc check valve, or any other type of check valve that allows flow of fluid in a first direction but restricts or prevents flow of fluid in a second, opposite direction.

The valve 754 is fluidly coupled with the first inlet line 752 and an intermediate line 788. The air valve 788 is fluidly coupled with the second inlet line 770 and the intermediate line 788. The intermediate line 788 may be or include a T-connector that feeds into the check valve 762 or the pump 760. The air inlet valve 758 may be fluidly coupled with the intermediate line 788 through a coupler 790 and may transition between an open and a closed position to allow air to enter the intermediate line 788 so that fluid may be returned or fall back into the tank 778 without requiring operation of the pump 760 (e.g., to de-pressurize the intermediate line 788). The pump 760 is fluidly coupled with the meter 764 through an outlet coupler 792 on its discharge side and is fluidly coupled with an intermediate line 798 through the coupler 794 on the suction side of the pump 760. The meter 764 is fluidly coupled with the outlet line 766, downstream of the pump 760 (e.g., on the discharge side of the pump 760).

### Direct Charge Control System

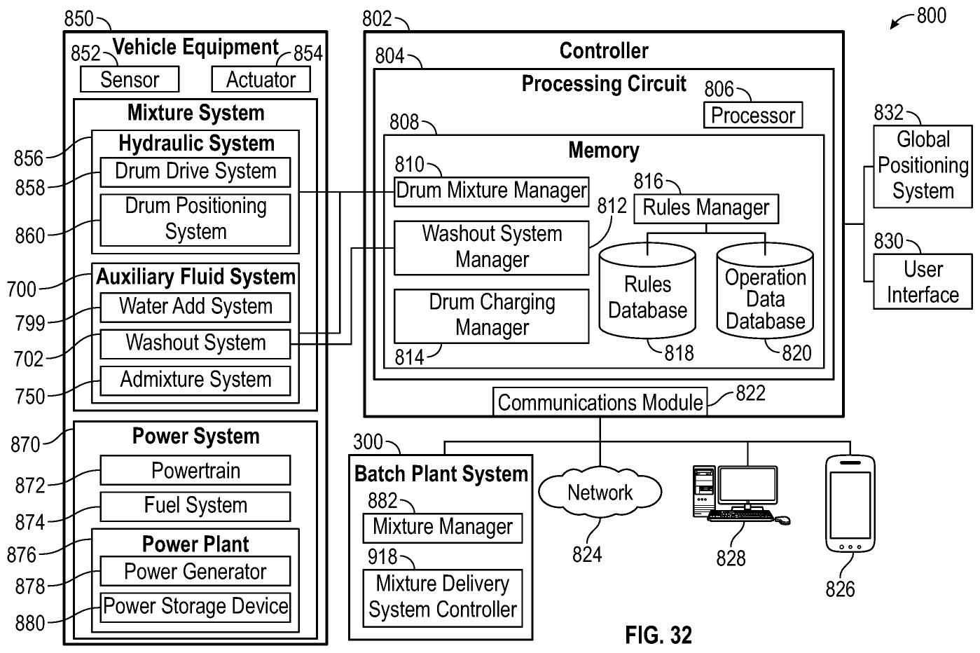

As shown in FIG. 32, the concrete mixer truck 10 may include a control system, shown as direct charge control system 800, for operating the concrete mixer truck 10 and/or the batch plant 300. Direct charge control system 800 includes a controller 802 that is communicably coupled with one or more systems of the concrete mixer truck 10 and/or one or more systems of the batch plant 300. Controller 802 may generate control signals for one or more systems of the concrete mixer truck 10 and/or the batch plant 300. For example, the controller 802 may generate control signals for the wash system 702 and/or the admixture system 750. The controller 802 can also receive information from the one or more systems of the concrete mixer truck 10 and/or the batch plant 300 and may use the information to generate control signals for one or more systems of the concrete mixer truck 10 and/or the batch plant 300. It should be understood that any operations of the one or more systems of the concrete mixer truck 10 and/or batch plant 300 described herein may be performed as a result of receiving control signals from controller 802. In this way, the one or more systems of the concrete mixer truck 10 and/or batch plant 300 and the various components thereof can be operated by a controller 802 of the direct charge control system 800.

Controller 802 is shown to include a processing circuit 804 including a processor 806 and memory 808. Processor 806 may be a general purpose or specific purpose processor, an application specific integrated circuit (ASIC), one or more field programmable gate arrays (FPGAs), a group of processing components, or other suitable processing components. Processor 806 is configured to execute computer code or instructions stored in memory 808 or received from other computer readable media (e.g., CDROM, network storage, a remote server, etc.).

Memory 808 may include one or more devices (e.g., memory units, memory devices, storage devices, etc.) for storing data and/or computer code for completing and/or facilitating the various processes described in the present disclosure. Memory 808 may include random access memory (RAM), read-only memory (ROM), hard drive storage, temporary storage, non-volatile memory, flash memory, optical memory, or any other suitable memory for storing software objects and/or computer instructions. Memory 808 may include database components, object code components, script components, or any other type of information structure for supporting the various activities and information structures described in the present disclosure. Memory 808 may be communicably connected to processor 806 via processing circuit 804 and may include computer code for executing (e.g., by processor 806) one or more processes described herein. When processor 806 executes instructions stored in memory 808, processor 806 generally configures the controller 802 (and more particularly the processing circuit 804) to complete such activities.

According to an exemplary embodiment, the memory 808 includes computer code modules (e.g., executable code, object code, source code, script code, machine code, etc.) configured for execution by the processing circuit 804. While the memory 808 may include various modules with particular functionality, it should be understood that the controller 802, the processing circuit 804, the processor 806, and the memory 808 may include any number of modules for completing the functions described herein. For example, the activities of multiple modules may be combined as a single module and additional modules with additional functionality may be included. Further, it should be understood that the controller 802 may further control other processes beyond the scope of the present disclosure.

As shown in FIG. 32, the memory 808 includes a drum mixture manager 810, a washout system manager 812, a drum charging manager 814, a rules manager 816, a rules database 818, and an operation data database 820. The drum mixture manager 810, washout system manager 812, drum charging manager 814, rules manager 816, rules database 818, and the operation data database 820 are described in additional detail below.

In some embodiments, the direct charge controller 802 includes a communications interface 822. The communications interface 822 can be or include wired or wireless communication interfaces (e.g., jacks, antennas, transmitters, receivers, transceivers, wire terminals, etc.) for conducting data communications with external systems or devices. In some embodiments, communications via communications interface 822 can be direct (e.g., local wired or wireless communications) or via a network 824. In some embodiments, the network 824 may be or include a wireless access network (WAN), the Internet, a cellular network, or still other suitable communication networks. In some embodiments, communications interface 822 can include a WiFi transceiver for communicating via a wireless communications network. In some embodiments, communications interface 822 may be or include cellular or mobile phone communications transceivers.

In some embodiments, the direct charge control system 800 includes a portable device, shown as user device 826, a network 824, and/or an external computing system resource (e.g., system resource, database, server, processor, virtual resource, etc.), shown as device 828. In some embodiments, one or more of the user device 826, the network 824, and/or device 828 may be communicably connected to the direct charge controller 802 (e.g., via communications interface 822). In some embodiments, the user device 826 may be a portable computing device which may include a processing circuit. In some embodiments, the user device 826 may connect to a network (e.g., network 824). In some embodiments, the user device 826 may facilitate a connection between the direct charge controller 802 and the network (e.g., network 824). For example, the user device 826 may be a smartphone that has a cellular connection to the Internet and a short-range wireless connection to the communications interface 822. In such example, the direct charge controller 802 may communicate with the Internet via a connection between the communications interface 822 and the user device 826.

In some embodiments, the device 828 may be or include one or more servers, databases, memory devices, processing circuits, or any other virtual or physical resource for the direct charge controller 802. In some embodiments, the device 828 may include a repository of data from one or more direct charge controllers 802. In some embodiments, the device 828 is structured and programmed to collect and store data of the direct charge control system 800 and may provide the data to the direct charge controller 802. In some embodiments, the device 828 includes one or more rules or algorithms for optimizing the performance of one or more of the components of the direct charge control system 800. The one or more rules or algorithms for optimizing the one or more components of the direct charge control system 800 may optimize performance based on data from one or more direct charge control systems 800. In some embodiments, the device 828 is a system (e.g., a computer system) usable by an administrator or producer of concrete handling equipment such as the concrete mixer truck 10 and batch plant 300. The device 828 may provide updates (e.g., software updates, software upgrades) for one or more systems of the direct charge control system 800. For example, the device 828 may update (e.g., populate, modify, manage, etc.) data stored in memory 808 and/or any module or portion of memory 808 (e.g., operation data database 820, rules database 818, etc.).

Still referring to FIG. 32, the controller 802 may be electrically coupled to a user interface (e.g., human machine interface (HMI), guided user interface, software, application, etc.), shown as user interface 830. According to some embodiments, the controller 802 is integrated within body controls (e.g., McNeilus FLEX controls, etc.) for the mixing element 122. The user interface 830 functions to receive inputs from a user (e.g., an operator of the concrete mixer truck 10, etc.). The controller 802 receives the inputs from the user interface 830 (e.g., via electronic communication, etc.) and provides commands to the one or more systems of the concrete mixer truck 10. The controller 802 can also receive information from the one or more systems of the concrete mixer truck 10 and present (e.g., display, show, organize, summarize, populate a graphical user interface, etc.) the received information to a user via the user interface 830.

In some embodiments, the user device 826 and/or the device 828 include input devices (e.g., buttons, keyboards, touch sensitive surfaces, cameras, microphones, etc.) and output devices (e.g., displays, speakers, etc.). In some embodiments, the user device 826 is associated with an operator (e.g., user, driver, manager, etc.) of concrete mixer truck 10. Data from the direct charge controller 802 (e.g., operation data database 820) may be presented to an operator of the direct charge control system 800 via the user device 826. For example, the user device 826 may indicate a system status (e.g., operating, inactive, offline, fault, error, etc.) or other system setting (e.g., a wash mode, an operational mode, a mixing mode, an admixture mode, current user preferences, etc.) via a display and/or other output device. In some embodiments, the user device 826 and/or device 828 may facilitate a user interacting with the direct charge controller 802 and generating commands for the one or more systems of the concrete mixer truck 10.

In some embodiments, the direct charge controller 802 is communicably connected to a positioning device or system, shown as global positioning system 832. The global positioning system 832 may determine a location of the refuse concrete mixer truck 10. The direct charge controller 802 may utilize real-time data (e.g., recent data, current data) from the global positioning system 832 to determine a location of the concrete mixer truck 10. For example, a direct charge controller 802 may utilize the global positioning system 832 to determine a proximity and route to a batch plant 300, a gas station, a job site (e.g., for timing a load and determining additive admixture quantities), a geofenced location, a boundary, a state line (e.g., for determining local rules and regulations related to operation of a concrete mixer truck 10), point of interest, or boundary. Data from the global positioning system 832 may be collected by the rules manager 816 and/or stored in operation data database 820. The data collected by the global positioning system 832 may be used by the direct charge controller 802 make control decisions. For example, the rules manager 816 may update, retrieve, and/or apply rules stored in rules database 818 based at least partially on the location of the concrete mixer truck 10 and/or other criteria.

As shown in FIG. 32, the direct charge control system 800 includes vehicle equipment 850. The vehicle equipment 850 may be or include one or more actuators (e.g., electric motors, hydraulic motors, hydraulic actuators, valves, fans, etc.) and sensors (e.g., position sensors, orientation sensors, velocity sensors, accelerometers, temperature sensors, weight sensors, volume sensors, angular position sensors, pressure sensors, etc.) for collecting data from the concrete mixer truck 10 and operating the concrete mixer truck 10. In some embodiments, the vehicle equipment 850 includes any controllable and/or electronically observable components of the concrete mixer truck 10. For example, a controllable component may be an actuator, a heating element, a pump, a motor, a subsystem controller, or other electronically influenced component. An electronically observable component may be a pressure sensor, a position sensor, a vehicle weight sensor, fuel level, or other electronically monitored (e.g., sensed, detected) aspect of the concrete mixer truck 10. As shown in FIG. 32, the vehicle equipment includes a sensor system, shown as sensor 852, and an actuator system, shown as actuator 854.

In some embodiments, the vehicle equipment 850 includes a hydraulic system 856. The hydraulic system 856 may include at least one actuator (e.g., hydraulic cylinder, hydraulic motor, etc.), accumulator, control valve (e.g., pneumatically operated control valve, hydraulically operated control valve, electrically operated control valve, etc.), pump (e.g., gear pump, vane pump, piston pump, etc.), check valve, filter, and/or reservoir. In some embodiments, the reservoir may hold a volume of hydraulic fluid for use in one or more hydraulic circuits of the hydraulic system 856. The reservoir may be or include a heat sink, and may transfer heat away from the hydraulic system 856 (e.g., to the ambient environment). The filter may filter contaminants from the hydraulic fluid flowing through a hydraulic circuit of the hydraulic system 856. The check valve may prevent backflow of hydraulic fluid in a hydraulic circuit. The check valve may also ensure a pressure is maintained downstream of the check valve. The pump may pressurize the hydraulic fluid in the hydraulic system 856 by displacing fluid volume against a resistant load or pressure. For example, the pump may pressurize hydraulic fluid in a hydraulic circuit to move the mixing drum 102. The control valve may control the flow of hydraulic fluid in the hydraulic system 856. For example, the control valve may start, stop, or direct a flow hydraulic fluid between or within one or more hydraulic circuits. The accumulator may maintain a pressure, reduce pressure spikes, store energy, and/or reduce vibrations in the hydraulic system 856. The actuator may convert energy imparted into the hydraulic fluid (e.g., from the pump) into mechanical energy. For example, a hydraulic cylinder may convert hydraulic energy into motion (e.g., raising or lowering a portion of the mixing drum 102) and work (e.g., lifting or pivoting the mixing drum 102).

In some embodiments the vehicle equipment 850 includes a system, shown as drum drive system 858, for driving a rotational motion of a mixing drum 102. In some embodiments, the drum drive system 858 includes a drum motor (e.g., drum motor 120). The drum motor 120 may be hydraulically powered (e.g., driven by a pressurized fluid). The hydraulic system 856 may supply pressurized hydraulic fluid to the drum motor to drive a rotation of the mixing drum 102 about the axis 110. In some embodiments, the vehicle equipment 850 includes a system, shown as drum positioning system 860. The drum positioning system 860 may include one or more actuators and one or more sensors for controlling the position and orientation of the mixing drum 102 relative to the frame 12 (e.g., actuator 610). In some embodiments, the one or more actuators for controlling the position and orientation of the mixing drum 102 may be hydraulically powered. In some embodiments, the one or more actuators for controlling the position and orientation of the mixing drum 102 may be electronically or otherwise powered.

As shown in FIG. 32, the vehicle equipment 850 includes a power system 870. The power system 870 may be configured to generate mechanical and electrical power for powering one or more of the systems of the concrete mixer truck 10 (e.g., the hydraulic system 856, the controller 802, a lighting system, a user comfort system, the auxiliary fluid system 700, etc.). The power system 870 may include a vehicle powertrain, shown as powertrain 872, and a fuel system 874. In some embodiments, the powertrain 872 includes the prime mover (e.g., engine 16), transmission, driveshaft, axles, differential, and other drive components of the concrete mixer truck 10 associated with driving the concrete mixer vehicle in a direction of travel. The fuel system 874 may be configured to store and supply a fuel (e.g., a liquid fuel, a gaseous fuel, a solid fuel, gasoline, compressed natural gas, liquefied petroleum gas, town gas, etc.) to the prime mover of the powertrain 872. In some embodiments, the prime mover of the powertrain 872 is an internal combustion engine. In other embodiments, the prime mover of the powertrain 872 is or includes an electrical motor. For example, the prime mover of the powertrain 872 may be an internal combustion engine, an electric motor, or a combination of an electric motor and an internal combustion engine (e.g., a hybrid system).

In some embodiments, the power system 870 includes a power plant 876. The power plant 876 may include a power generating device or system (e.g., an alternator, a solar panel, an array of solar panels etc.), shown as power generator 878. The power generator 878 may generate electrical energy for powering one or more systems of the concrete mixer truck 10. In some embodiments, the power generator 878 may generate electrical energy and one or more power storage devices (e.g., a battery, a battery cell, an array of battery cells, a capacitor, a bank of capacitors, etc.), shown as power storage device 880, may store energy generated by the power generator 878 and regulate the energy output from the power plant 876. In some embodiments, the power generator 878 is powered by the prime mover of the powertrain 872.

As shown in FIG. 32, the batch plant 300 includes a mixture manager 882 and a mixture output system manager, shown as mixture delivery system controller 918. The mixture manager 882 may generate control signals for one or more of the cement supply 204, the aggregate supply 206, the liquid supply 208, the cement apportioning device 230, the transport system 240, the apportioning device 244, the batch plant mixer system 210, and/or other components and systems of the batch plant 300. The mixture manager 882 may receive data from one or more systems of the batch plant 300. For example, a controller or for the cement supply 204 may be configured to provide a status (e.g., a fill level, a state of a component, a temperature, an operational status, etc.) of the cement supply 204 which may be retrieved by or output to the mixture manager 882. The mixture manager 882 may be communicably coupled to one or more systems of the batch plant 300. For example, the mixture manager 882 may be wirelessly and/or wiredly connected to the batch plant mixer system 302. The systems of the batch plant 300 may be communicably connected (e.g., by the communications interface 822) to one or more subsystem controllers associated with the subsystems of the direct charge control system 800.

As shown in FIGS. 8 and 32, batch plant 300 includes a batch plant control system 910. The batch plant control system 910 may include a batch plant controller 912, a cement supply controller 914, an aggregate supply controller 916, and a mixture delivery system controller 918. Each of the controllers 912, 914, 916, 918 may be in wired and/or wireless communication and may communicate over a network with one or more local or remote devices. For example, the controllers 912, 914, 916, 918 may be in wireless communication via a connection with wireless transceiver 920. Controllers 912, 914, 916, and 918 may include a processing circuit having a processor and a memory configured to store instructions thereon that when executed by the one or more processors, cause the one or more processors to execute one or more of the operations described herein. Each of the controllers 912, 914, 916, 918 may be communicably connected with one or more sensors (e.g., encoders, position sensors, rotational sensors, flow sensors, moisture sensors, weight sensors, light sensors, cameras, temperature sensors, etc.) and/or one or more actuators (e.g., rotational actuators, motors, linear actuators, hydraulic actuators, electric motors, solenoids, stepper motors, etc.) that facilitate monitoring and controlling one or more function or operation of the batch plant 300. For example, the cement supply controller 914 may be communicably connected with one or more actuators (e.g., a motor, etc.) for driving a cement dispensing mechanism (e.g., a screw, gate, valve, etc.) and/or operating the apportioning device 230.

In some embodiments, the mixture delivery system controller 918 may be communicably connected with and configured to control at least one of the transport mechanism 250, the batch plant mixer system 302, or the chute 400. In some embodiments, one or more of the components of batch plant 300 (e.g., aggregate supply 206, cement supply 204, transport mechanism 250, batch plant mixer system 302, chute 400, etc.) are controlled by a centralized (e.g., primary, main, etc.) controller (e.g., batch plant controller 912, direct charge controller 802). As shown, batch plant controller 912 is located proximate the batch plant operator structure 322. In some embodiments, a batch plant operator may control the operation of the batch plant 300 by interacting with batch plant controller 912 (e.g., by providing an input to a user interface connected to the batch plant controller 912). In some embodiments, the batch plant controller 912 is located remotely from the batch plant 300 (e.g., spaced from the batch plant, off premises, off campus, etc.). In some embodiments, the batch plant controller 912 is at least partially network based (e.g., implemented at least partially on one or more processors and one or more memory devices communicably connected via a network). In some embodiments, one or more of the controllers 912, 914, 916, 918 may be integrated into or part of (e.g., a module of) the direct charge controller 802. As shown in FIG. 8, the direct charge controller 802 is located onboard the concrete mixer truck 10. In other embodiments, some or all of the direct charge controller 802 is positioned differently and may be remote from the concrete mixer truck 10.

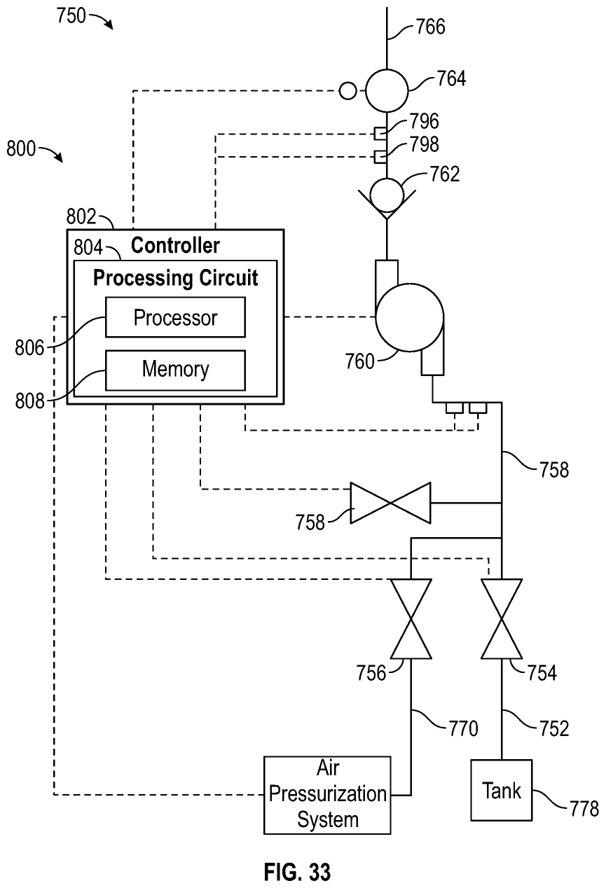

As shown in FIG. 33, the direct charge control system 800 is shown in greater detail and according to an exemplary embodiment. The direct charge controller 802 may be configured to operate the admixture system 750. As shown, the controller 802 is communicably coupled with the pump 760, the meter 764, the air inlet valve 758, the air valve 756, and the valve 754. The controller 802 can be configured to operate any of the pump 760, the air inlet valve 758, the air valve 756, or the valve 754. For example, the controller 802 may generate control signals for the pump 760 to operate the pump 760 at various speeds. The controller 802 may also generate control signals for any of the air inlet valve 758, the air valve 756, or the valve 754 to transition the valves 754-758 between their open positions and closed positions. The controller 802 can also receive the meter information from the meter 764 and may use the meter information to generate the control signals for the pump 760, the valve 754, the air valve 756, and/or the air inlet valve 758. It should be understood that any operations of the pump 760, the valve 754, the air valve 756, and/or the air inlet valve 758 as described herein may be performed as a result of receiving control signals from the controller 802. In this way, admixture system 750 and the various controllable components thereof can be operated by controller 802 of the direct charge control system 800. Other components and subsystems of the direct charge control system 800 (e.g., wash system 702, drum drive system 858, batch plant 300, etc.) may have similar controllable components (e.g., the same or similar type, the same or similar functionality, etc.) as the controllable components of the admixture system 750. The controllable components of the subsystems and components of the direct charge control system 800 may be controllable similarly to the controllable components of the admixture system 750.

During operation of the admixture system 750, the valve 754 is transitioned into the open position or state so that fluid may be drawn by the pump 760 from the tank 778. The valve 754 may be transitioned into the open position by controller 802. For example, controller 802 may generate control signals for the valve 754 to transition the valve 754 from the closed position/state to the open position/state or to ensure that the valve 754 is currently in the open position/state. The controller 802 may also generate control signals for air inlet valve 758 and air valve 756 so that the air inlet valve 758 and the air valve 756 are transitioned into or maintained in their closed positions/states. With the valve 754 opened, the air inlet valve 758 closed, and the air valve 756 closed, the pump 760 may operate so that a desired amount of fluid is discharged into the mixing drum 102.

The controller 802 can operate the pump 760 while monitoring the meter information received from meter 764 so that the desired amount of fluid is discharged into mixing drum 102. The controller 802 may receive the meter information from meter 764 and operate pump 760 according to a closed-loop control scheme. Controller 802 may also account for volume, mass, or amount of fluid present in the admixture system 750 upstream of the meter 764 but downstream of the pump 760, or volume, mass, or amount of fluid present in the admixture system 750 upstream of the meter 764 but downstream of the check valve 762.

As shown in FIGS. 8, 12-14, and 32, the direct charge controller 802 is configured to operate chute 400. In some embodiments, the direct charge controller 802 may be or include the mixture delivery system controller 918. The mixture delivery system controller 918 may be communicably connected to one or more sensors (e.g., linear position sensors, angular position sensors, cameras, positioning system sensors, etc.) and one or more actuators (e.g., actuators 428, 432, 448, 460). In operation, the mixture delivery system controller 918 may monitor and store values of one or more sensors and based on the values generate control signals for operating the one or more actuators of the chute 400. In some embodiments, the mixture delivery system controller 918 may automatically generate control signals for positioning the chute 400 proximate the opening of the mixing drum 102. For example, one or more sensors communicably coupled to the mixture delivery system controller 918 may facilitate the mixture delivery system controller 918 determining a location, position, and orientation the mixing drum 102 relative to the chute 400 (e.g., the chute outlet 408). The mixture delivery system controller 918 may determine a series of steps based at least partially on rules stored in a rules database (e.g., rules database 818) and the determined position of the mixing drum 102. The series of steps may include steps for repositioning the chute 400 to a desired position and orientation relative to the mixing drum 102. In this way, the chute 400 may be repositioned to automatically accommodate variations the position, orientation, and types of concrete mixer truck 10.

By way of example, the mixture delivery system controller 918 may identify that a position, orientation, and location of a mixing drum 102 and the opening of the mixing drum 102 is positioned differently than would be accommodated by a detected current position of the chute 400 (e.g., the positioned used during a previous direct charge operation, a home position of the chute 400, etc.) according to a set of rules (e.g., the rules stored in rules database 818). The mixture delivery system controller 918 may utilize data from the vehicle equipment 850 to determine relevant parameters and states of the concrete mixer truck 10. The mixture delivery system controller 918 may then determine one or more steps (e.g., movements, commands, signals, etc.) for repositioning the chute 400 to accommodate the determined position, orientation, and location of the mixing drum 102. The mixture delivery system controller 918 may then execute the one or more steps to reposition the chute 400. In some embodiments, in response to the position and orientation of the chute 400 satisfying one or more rules (e.g., a rule that a position and/or orientation of the chute outlet 408 relative to a point or location of the concrete mixer truck 10 must be above, below, or between, one or more threshold values), the mixture delivery system controller 918 may trigger or control a discharge of material through the chute 400. For example, the mixture delivery system controller 918 may control the batch plant mixer discharge gate system 332 into an open position to allow materials to exit the batch plant mixer system 302 and enter the chute 400.

In some embodiments, the mixture delivery system controller 918 may be configured to receive an input from a user (e.g., via a user interface 830, via a user device 826, via a device 828, etc.) to reposition the chute 400. The user input may include an input to activate the mixture delivery system controller 918 to automatically reposition the chute 400. For example, a user may interact with a user input device (e.g., a touch sensitive surface, button, actuator, switch, a virtual button or interface on a GUI, etc.) to activate the mixture delivery system controller 918. In some embodiments, the input to activate the automatic repositioning function of the mixture delivery system controller 918 is generated automatically (e.g., without a user input). For example, the input to active the automatic repositioning function of the mixture delivery system controller 918 based on signals received from the global positioning system 832 or a different system (e.g., a camera system, a proximity detector, etc.). In some embodiments, a user may interact with a user input device of the user interface 830, user device 826, and/or device 828 to manually adjust the position of the chute 400. For example, a user may interact with a joystick, buttons, touch sensitive surface, microphone, camera, and/or other input device to reposition the chute 400 and the components thereof.

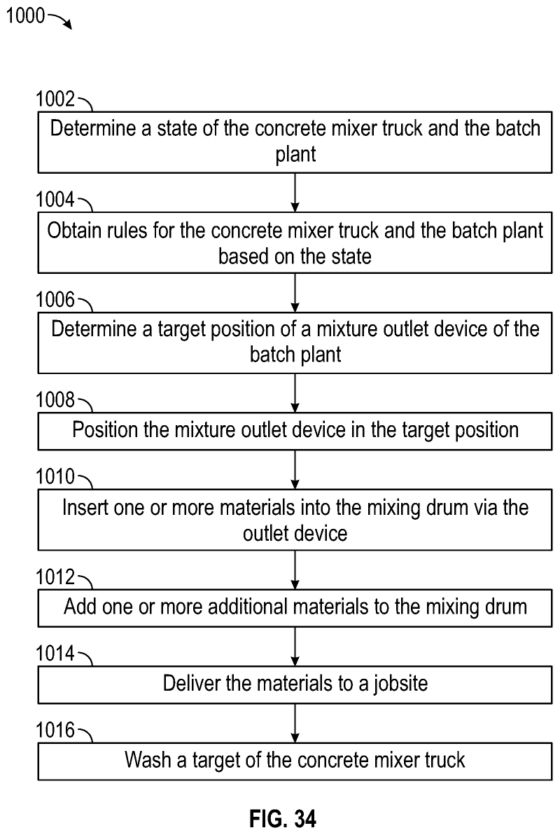

Referring now to FIG. 34, a flow diagram of a process 1000 for controlling a direct charge control system 800 is shown, according to some embodiments. Process 1000 may be performed by a data processing system (e.g., the direct charge controller 802), which may be communicably coupled to the concrete mixer truck 10. Process 1000 may include any number of steps and the steps may be performed in any order.

At a step 1002, the data processing system determines a state of a direct charge system, according to some embodiments. The state of a direct charge system may include the state of a concrete mixer truck 10 and/or a state of a batch plant (e.g., batch plant 300). The state of the concrete mixer truck 10 may include determining a status (e.g., operating, driving, parked, mixing, dispensing, loading, washing, idle, assigned to a job, a current drum position, a subsystem status, etc.) and/or a characteristic of the concrete mixer truck 10 (e.g., a mixing drum capacity, a payload capacity, a drum height, a range of motion of the mixing drum 102, a mixing drum size, a mixing drum orientation, a mixing drum configuration, a mixing drum opening size and shape, available chute positioning features, a manufacturer specifications, etc.). The state of the batch plant may include determining a status of the batch plant (e.g., offline, active, at capacity, operational, preparing a mixture, dispensing a mixture, dispensing a material, refilling a material, a chute position, etc.) and/or a characteristic of the batch plant (e.g., a material supply capacity, a batch plant mixing mechanism type and capacity, a static or adjustable dispensing mechanism, an adjustable chute range of motion, a chute accommodation envelope, a material dispensing capacity, a material dispensing rate, a type of material available, etc.). In some embodiments, the drum charging manager 814 may periodically or continuously determine the state of the direct charge control system 800 and store the state of direct charge system in a database (e.g., operation data database 820).

At a step 1004, the data processing system obtains a set of rules based on the state of the direct charge system, according to some embodiments. In some embodiments, the rules manager 816 may query rules database 818 for rules based on the state of the direct charge system. For example, the rules manager 816 may query rules database for rules which are applicable to the concrete mixer truck 10 and/or the batch plant. The rules database 818 may be a repository of rules for various work vehicles (e.g., concrete mixer trucks 10, dump trucks, pickup trucks, etc.), and/or batch plants (e.g., dry mix concrete plant, wet mix concrete plant, direct charge batch plant, etc.). In some embodiments, the rules stored in rules database 818 may be periodically updated by the rules manager 816. In such embodiments, the rules manager 816 may periodically communicate with one or more external devices (e.g., device 828) to determine if an update to one or more rules stored in rules database 818 is available, and may facilitate the update.

In some embodiments, a rule may include a condition that if the drum charging manager 814 determines that a characteristic of a mixture of materials within the mixing drum 102 does not have a target value (e.g., a predetermined value, a user defined value, a threshold value, etc.), the drum mixture manager 810 should command the admixture system 750 and/or the drum drive system 858 to adjust the composition or characteristic according to one or more predefined relationships (e.g., data tables). For example, a rule may include a condition that if the drum mixture manager 810 determines that a detected value of a mixture within a mixing drum 102 does not satisfy a threshold for slump, the drum mixture manager 810 may control the water add system 799 to add water to the mixing drum 102 to increase slump, and/or may control the admixture system to add a water reducing admixture material and/or a superplasticizer. A rule may include a condition that if the washout system manager 812 determines that the concrete mixer truck 10 completed a mixture dispensing operation (e.g., by monitoring the weight of the vehicle, by monitoring a rotational inertia of the mixing drum 102, etc.) the washout system manager 812 should activate the wash system 702 to wash and/or clean a target of the mixing drum 102. A person having ordinary skill in the art will appreciate that a large number of rules and combinations of rules are possible and the examples described herein are for illustration only.

In some embodiments, the rules stored in rules database 818 may be rules for positioning the chute 400 to accommodate a position and orientation of a mixing drum 102. For example, a rule may include a condition that if the drum charging manager 814 determines that a mixing drum 102 is located proximate (e.g., below, within a predefined distance, etc.) of the chute 400 of the batch plant 300, the state (e.g., position, orientation, location, etc.) of the chute 400 should be compared to a determined accommodating position (e.g., a direct charge position) of the chute 400 based on the state (e.g., position, orientation, location, characteristic, status, etc.) of the mixing drum 102. In such example, the rule may further include a condition that if the comparison between the state of the chute 400 and a determined or retrieved target accommodating position of the chute 400 is outside of a threshold, the drum charging manager 814 should provide one or more commands to the mixture delivery system controller 918 to adjust chute 400 to the target accommodating position.

At a step 1006, the data processing system may determine a target position of a mixture outlet device of the batch plant, according to some embodiments. In some embodiments, the drum charging manager 814 may determine a target position (e.g., a target accommodation position) of the chute 400. In some embodiments, the target accommodating position of the chute 400 may be retrieved from a database, or may be determined using one or more rules or algorithms. For example, an algorithm may include variables representing the state of the chute 400 (e.g., position, orientation, location, axial position, relative position, component positions, etc.) and the state of the concrete mixer truck 10, which the drum charging manager 814 can utilize by evaluating the algorithm using one or more data values stored in the operation data database 820 to determine the target accommodating position of the chute 400. The target accommodating position may be a position of the chute 400 in which a flow of material exiting the chute 400 is entirely deposited within the mixing drum 102. For example, the target accommodating position may be or include setpoint values (e.g., setpoints) determined by the drum charging manager 814 for the controllable devices of the chute 400 that, based on the current state of the mixing drum 102, cause the chute 400 to be positioned such that the materials exiting the chute 400 are inserted into the mixing drum 102.

In some embodiments, the target accommodating position of the chute 400 may be a position in which the chute outlet 408 is disposed within the interior volume of the mixing drum 102. For example, a target accommodating position of the chute 400 may be a position in which a portion of the chute 400 extends into the mixing drum 102 (e.g., through the mixing drum aperture 104) at a predefined distance (e.g., an inch, a foot, three feet, six feet, etc.) to prevent material from being misplaced by the chute 400.

In some embodiments, the target accommodating position of chute 400 may be a position in which the chute outlet 408 is positioned outside of the mixing drum 102. In such examples, the material may be directed into a hopper or funnel for directing material into the mixing drum 102, or may travel freely through a space outside of the mixing drum 102 prior to entering the mixing drum 102. In some embodiments, an algorithm for determining the target accommodating position may use or include a determined trajectory of the material between the chute outlet 408 and the interior of the mixing drum 102 (e.g., to determine the path of the bulk fluid moving through the space to ensure the material is inserted into the mixing drum 102). In some embodiments, the target accommodating position of the chute 400 is a position in which a portion of chute outlet 408 engages with or contacts one or more portions of the direct charge drum assembly 100. For example, the direct charge drum assembly 100 may include a shield, door, flap, or other component configured to block debris from entering the mixing drum 102. The target accommodating position of the chute 400 may be a position in which a portion of the chute 400 passes through the shield, door, flap, or other component to allow the mixture to enter the mixing drum 102.

In some embodiments, the drum charging manager 814 determines a target accommodating position and one or more intermediate target positions between the current position of the chute 400 and the target accommodating position of the chute 400. For example, the drum charging manager 814 may determine one or more intermediate target positions to ensure the chute 400 does not unintentionally contact or damage the concrete mixer truck 10 during a repositioning motion of the chute 400 between the current position and the target accommodating position.

At a step 1008, the data processing system may position the mixture outlet device in the target position, according to some embodiments. The drum charging manager 814 may reposition the chute 400 in a target accommodating position. The drum charging manager 814 may compare the value of a sensor (e.g., the collision avoidance sensor 470, drum charging sensor 160, etc.) to one or more threshold values and may control the motion of the chute 400 according to one or more rules stored in the rules database 818. The drum charging manager 814 may determine a position and orientation of the mixing drum 102 using a sensor (e.g., collision avoidance sensor 470), actuator position, setpoint, or other point. Based on the determined position and orientation of the mixing drum 102, the drum charging manager 814 may provide command signals to the mixture delivery system controller 918 to move the chute 400 into the target accommodation position. The chute 400 may be in a first position (e.g., position 572) and the drum charging manager 814 use a determined position and orientation of the mixing drum 102 to determine or retrieve a target accommodation position (e.g., position setpoints) for the chute 400. In some embodiments, the drum charging manager 814 may provide command signals to the mixture mixture delivery system controller 918 to move the ramp 600 and chute 400, and also provide command signals to the drum positioning system 860 to control the motion of the actuator 610 to achieve respective or a combined target accommodation position for each system.

At a step 1010, the data processing system may insert one or more materials into the mixing drum via the outlet device, according to some embodiments. The drum charging manager 814 may position the chute 400, and may provide a signal to the mixture delivery system controller 918 to open the batch plant mixer discharge gate system 332. In some embodiments, the drum mixture manager 810 may generate a signal for the mixture manager 882 to operate one or more systems of the batch plant 300 according to a user input or desired mixture composition. Material from the batch plant 300 may be inserted directly into the chute 400, or may be mixed by the batch plant mixer mechanism 330 and subsequently inserted directly into the chute 400. The chute 400 may provide the material or mixture of material into the mixing drum 102 without misplacing material.

At a step 1012, the data processing system may add one or more additional materials to the mixing drum, according to some embodiments. The drum mixture manager may 810 may use a value of one or more sensors to determine a characteristic or composition of the material stored within the mixing drum 102. The drum mixture manager 810 may use the determined characteristic or composition and one or more rules to determining an amount of additional materials needed to achieve a target characteristic of composition of materials within the mixing drum 102. For example, a location of a jobsite and a desired material characteristic (e.g., slump, humidity, composition, etc.) may be provided by a user and the drum mixture manager 810 may determine a quantity of one or more additives that should be added to the mixing drum 102 to achieve the material characteristic upon arrival at the jobsite. For example, the drum mixture manager 810 may determine that a quantity (e.g., two liters) of an admixture material should be added to the mixing drum 102 at a first point in time (e.g., immediately), and an additional quantity of a same or different admixture material should be added at a second point in time (e.g., 20 minutes before arriving at the jobsite). The drum mixture manager 810 may determine a drum mixing intensity (e.g., mixing drum rotational rate, an angular offset of axis 110, etc.) and a drum mixing duration based on the location of a jobsite and/or a desired material characteristic. In some embodiments, the drum mixture manager 810 is configured to automatically retrieve the jobsite location, target mixture composition, and target mixture characteristics from a device 828 and/or network 824. In some embodiments, an administrator or manager of a direct charge control system 800 may store active orders and jobs on a communicably connected memory device (e.g., operation data database 820, device 828, etc.) which may be available to the drum mixture manager 810 without a user input.

At a step 1014, the data processing system may deliver the materials to a jobsite, according to some embodiments. A concrete mixer truck 10 having a mixture within the mixing drum 102 may transport the mixture to the jobsite. The drum mixture manager 810 may monitor and adjust a characteristic of a mixture of materials within the mixing drum 102. The drum mixture manager 810 may control the drum drive system 858 to dispense the material form the mixing drum 102.

At a step 1016, the data processing system may clean a target of the concrete mixer truck 10, according to some embodiments. The drum mixture manager 810 may monitor and identify when mixture has been dispensed or removed from the mixing drum 102. Subsequent to identifying that the mixture has been dispensed or removed from the mixing drum 102, the drum mixture manager 810 may generate a control signal to operate one or more systems of the vehicle equipment 850. For example, the drum mixture manager 810 may signal the washout system manager 812 to generate command signals for operating the wash system 702 to clean one or more targets of the concrete mixer truck 10.

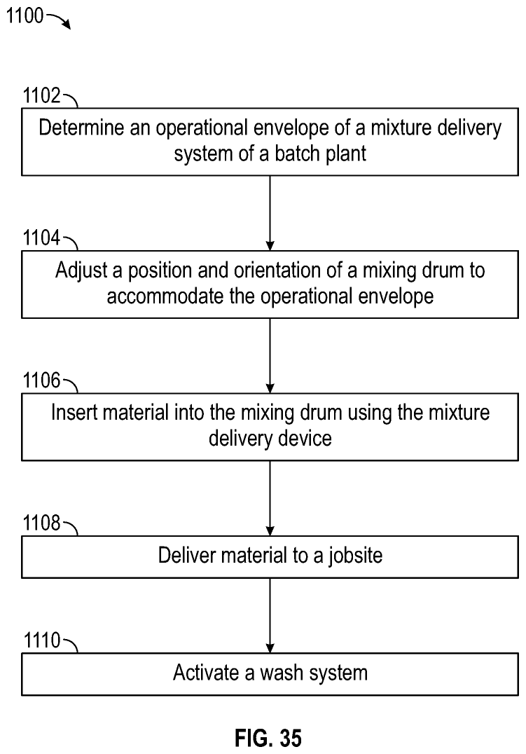

Referring now to FIG. 35, a flow diagram of a process 1100 for controlling a direct charge control system 800 is shown, according to some embodiments. Process 1100 may be performed by a data processing system (e.g., the direct charge controller 802), which may be communicably coupled to the concrete mixer truck 10. Process 1100 may include one or more steps of the process 1000. Process 1100 may include any number of steps and the steps may be performed in any order.

At a step 1102, a data processing system may determine an operational envelope of a mixture delivery system of a batch plant, according to some embodiments. The operational envelope may be an envelope (e.g., area, volume, space, etc.) that can be occupied by an opening of a mixing drum 102 to receive a material from the chute 400. For example, the chute 400 may have an operational envelope located directly below the chute outlet 408 (e.g., the chute 400 may be fixed) or may have degrees of freedom that support a larger operational envelope which may accommodate a larger variation of positions and orientation of a mixing drum 102. The degrees of freedom of the chute 400 may allow the chute 400 to achieve a target accommodating position. The target position may be a position in which the chute 400 inserts material directly into the mixing drum 102 with virtually no splattered, spilled, dropped, lost, or otherwise misplaced material. In some embodiments, the chute 400 may include a mechanism or structure that may at least partially blocks the chute outlet 408 to prevent left over material within the chute from dripping or falling from the chute 400 between charging operations.

At a step 1104, a data processing system may adjust a position and orientation of a mixing drum (e.g., mixing drum 102) to accommodate the operational envelope of the chute 400, according to some embodiments. The drum charging manager 814 may command the drum positioning system 860 to reposition the mixing drum 102 to accommodate the operational envelope of the chute 400. The drum positioning system 860 may be configured to control at least one of the actuator 610, and/or the ramp 600. The drum charging manager 814 may command the actuator 610 and/or the ramp 600 to raise, lower, slide, rotate, etc., the opening of the mixing drum 102 relative to the operational envelope of the chute 400. In some embodiments, the drum charging manager 814 may control the drum positioning system 860 and the mixture delivery system controller 918 concurrently or consecutively. For example, the drum charging manager 814 may control the drum positioning system 860 to enter a portion of the operational envelope of the chute 400. Consecutively or concurrently, the drum charging manager 814 may command the chute 400 to a target accommodating position that is based on an anticipated or current location of the mixing drum within the operational envelope of the chute 400.

At a step 1106, a data processing system may insert material into the mixing drum using the mixture delivery system, according to some embodiments. The drum charging manager 814 may position the chute 400, and may provide a signal to the mixture delivery system controller 918 to open the batch plant mixer discharge gate system 332. In some embodiments, the drum mixture manager 810 may generate a signal for the mixture manager 882 to operate one or more systems of the batch plant 300 according to a user input or desired mixture composition. Material from the batch plant 300 may be inserted directly into the chute 400, or may be mixed by the batch plant mixer mechanism 330 and subsequently inserted directly into the chute 400. The chute 400 may deliver the material or mixture of material into the mixing drum 102 without misplacing material.

At a step 1108, the data processing system may deliver the materials to a jobsite, according to some embodiments. A concrete mixer truck 10 having a mixture within the mixing drum 102 may transport the mixture to the jobsite (e.g., automatically via an artificial intelligence (AI) or machine learning (ML) control system, etc.). The drum mixture manager 810 may monitor and adjust a characteristic of a mixture of materials within the mixing drum 102. The drum mixture manager 810 may control the drum drive system 858 to dispense the material form the mixing drum 102.

At a step 1110, the data processing system may active a wash system, according to some embodiments. The drum mixture manager 810 may signal the washout system manager 812 to generate command signals for operating the wash system 702 to clean one or more targets of the concrete mixer truck 10. The drum mixture manager 810 may monitor and identify when mixture has been dispensed or removed from the mixing drum 102. Subsequent to identifying that the mixture has been dispensed or removed from the mixing drum 102, the drum mixture manager 810 may generate a control signal to operate one or more systems of the vehicle equipment 850. For example, the drum mixture manager 810 may signal the washout system manager 812 to generate command signals for operating the wash system 702 to clean one or more targets of the concrete mixer truck 10. In some embodiments, a user may activate and/or operate the wash system 702.

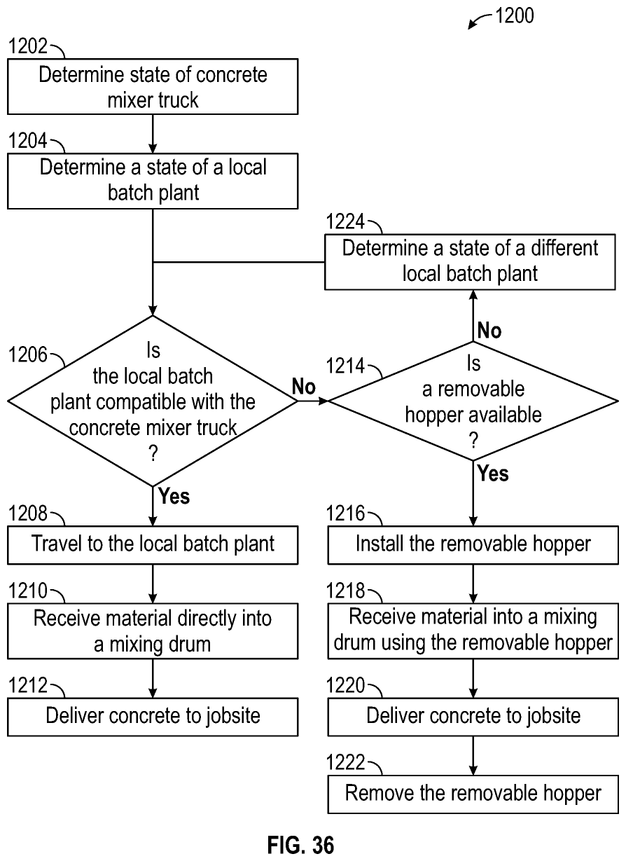

Referring now to FIG. 36, a flow diagram of a process 1200 for operating a concrete mixer vehicle of a direct charge control system 800 is shown, according to some embodiments. Process 1100 may be performed by a data processing system (e.g., the direct charge controller 802), which may be communicably coupled to the concrete mixer truck 10. Process 1200 may include one or more steps of the process 1000 and/or the process 1100. Likewise, the processes 1000, 1100 may include one or more steps of the process 1200. Process 1200 may include any number of steps and the steps may be performed in any order.

At a step 1202, a data processing system may determine a state of a concrete mixer truck, according to some embodiments. The state of the concrete mixer truck 10 may include determining a status (e.g., operating, driving, parked, mixing, dispensing, loading, washing, idle, assigned to a job, a current drum position, a subsystem status, etc.) and/or a characteristic of the concrete mixer truck 10 (e.g., a mixing drum capacity, a payload capacity, a drum height, a range of motion of the mixing drum 102, a mixing drum size, a mixing drum orientation, a mixing drum configuration, a mixing drum opening size and shape, available chute positioning features, a manufacturer specifications, etc.). In some embodiments, the drum charging manager 814 may periodically or continuously determine the state of the concrete mixer truck 10 and store the state of the concrete mixer truck 10 in a database (e.g., operation data database 820). In some embodiments, the drum charging manager 814 may receive or retrieve data from the global positioning system 832 to determine a list of one or more batch plants 300 within a predefined distance of the concrete mixer truck 10 and/or a one or more jobsites.

At a step 1204, the data processing system may determine a state of a local batch plant, according to some embodiments. In some embodiments, the drum charging manager 814 may receive or retrieve data from the global positioning system 832 to determine a list of one or more batch plants 300 within a predefined distance of the concrete mixer truck 10 and/or a one or more jobsites. The state of the batch plant 300 may include determining a status of the batch plant 300 (e.g., offline, active, at capacity, operational, preparing a mixture, dispensing a mixture, dispensing a material, refilling a material, a chute position, etc.) and/or a characteristic of the batch plant 300 (e.g., a material supply capacity, a batch plant mixing mechanism type and capacity, a static or adjustable dispensing mechanism, an adjustable chute range of motion, a chute accommodation envelope, a material dispensing capacity, a material dispensing rate, a type of material available, etc.). In some embodiments, the drum charging manager 814 may periodically or continuously determine the state of one or more local batch plants 300 (e.g., batch plants 300 within a predefined distance of the concrete mixer truck 10 and/or one or more jobsites). In some embodiments, the drum charging manager 814 may store the state of the one or more local batch plants 300 in a database (e.g., the operation data database 820).

At a step 1206, the data processing system may determine if the local batch plant is compatible with the concrete mixer truck, according to some embodiments. The drum charging manager 814 may utilize a determined state of the local batch plant to determine if the batch plant is a direct charge batch plant. For example, the drum charging manager 814 may determine if the batch plant 300 includes a chute 400 and a ramp 600 that can accommodate a direct charge drum assembly 100. In some embodiments, the drum charging manager 814 may use a determined state of the concrete mixer truck 10 to determine the operational ranges of the drum positioning system 860. The drum charging manager 814 may utilize the operational envelope of the chute 400, an operational range of the ramp 600, and/or an operational range of a drum positioning system 860 to determine if the direct charge drum assembly 100 of the concrete mixer truck 10 is compatible with the charging systems of the batch plant 300. In some embodiments, if the drum charging manager 814 determines that the direct charge drum assembly 100 is compatible with the batch plant 300, the process 1200 may continue with a step 1208. In some embodiments, if the drum charging manager 814 determines that the direct charge drum assembly 100 is not compatible with the batch plant 300, the process 1200 may continue with a step 1214.

At a step 1208, the data processing system may travel to the local batch plant, according to some embodiments. In some embodiments, an operator may drive the concrete mixer truck 10 to a batch plant 300 and position an opening of the mixing drum 102 proximate the chute 400.

At a step 1210, the data processing system may receive material directly into a mixing drum, according to some embodiments. The drum charging manager 814 may reposition the chute 400 in a target accommodating position as described above. The drum charging manager 814 may compare the value of a sensor (e.g., the collision avoidance sensor 470) to one or more threshold values and may control (e.g., move, cancel, undo, stop, reroute, inhibit, temporarily inhibit, etc.) the motion of the chute 400 according to one or more rules stored in the rules database 818. The drum charging manager 814 may determine a position and orientation of the mixing drum 102 using a sensor (e.g., collision avoidance sensor 470), actuator position, setpoint, or other point. The chute 400 may be in a first position (e.g., position 572) and the drum charging manager 814 use a determined position and orientation of the mixing drum 102 to determine or retrieve a target accommodation position (e.g., position setpoints) for the chute 400. The drum charging manager 814 may provide command signals to the mixture delivery system controller 918 to move the chute 400 into the target accommodation position. The drum charging manager 814 may provide a signal to the mixture delivery system controller 918 to open the batch plant mixer discharge gate system 332. In some embodiments, the drum mixture manager 810 may generate a signal for the mixture manager 882 to operate one or more systems of the batch plant 300 according to a user input or desired mixture composition. Material from the batch plant 300 may be inserted directly into the chute 400, or may be mixed by the batch plant mixer mechanism 330 and subsequently inserted directly into the chute 400. The chute 400 may provide the material or mixture of material into the mixing drum 102 without misplacing material. The drum mixture manager may 810 may use a value of one or more sensors to determine a characteristic or composition of the material within the mixing drum 102. The drum mixture manager 810 may use the determined characteristic or composition and one or more rules to determine an amount of additional materials needed to achieve a target characteristic of composition of materials within the mixing drum 102.

At a step 1212, the data processing system may deliver concrete to a jobsite, according to some embodiments. A concrete mixer truck 10 having a mixture within the mixing drum 102 may facilitate a user transporting the mixture to the jobsite. The drum mixture manager 810 may monitor and adjust a characteristic of a mixture of materials within the mixing drum 102 during transit to the jobsite. The drum mixture manager 810 may control the drum drive system 858 to dispense the material form the mixing drum 102 in response to a user input, an automatically generated signal, and/or a remote signal (e.g., a signal generated by a user spaced from the concrete mixer truck 10).

At a step 1214, the data processing system may determine if a removable charge hopper is available, according to some embodiments. The drum charging manager 814 may use a determined state of the concrete mixer truck 10 to determine if a hopper 150 may be removably coupled to the mixing drum 102. For example, the state of the concrete mixer truck 10 may include a unique identifier (e.g., serial number, model number, data tag, data object, data attribute, etc.) associated with the concrete mixer truck 10. The drum charging manager 814 may use the unique identifier as a query key to find (e.g., lookup, query, search, etc.) data stored in a database or data table (e.g., a manufactures data table, a data table, a data table stored in operation data database 820, etc.) associated with the unique identifier. The data associated with the unique identifier may be retrieved by the drum mixture manager and used to define or determine a value of state variables of a state of the concrete mixer truck 10. The state values of the state variables may be used by the drum charging manager 814 to determine one or more equipped or available features (e.g., operational ranges, available equipment, available systems, etc.) of the concrete mixer truck 10. In some embodiments, the drum charging manager 814 may use a determined state of the batch plant 300 to determine if a charge hopper is available (e.g., present, available for use, etc.). If the drum charging manager 814 determines that a hopper 150 is available at the batch plant 300 and the concrete mixer truck 10 is compatible with the hopper 150, the process 1200 may continue with step 1216. If the drum charging manager 814 determines that a hopper 150 is not available at the batch plant 300 and/or the concrete mixer truck 10 is not compatible with the hopper 150, the process 1200 may continue with step 1224.

At a step 1216, a data processing system may install a removable hopper, according to some embodiments. The drum charging manager 814 may present information and instructions on a graphical user interface associated with a display of the user interface 830, user device 826, and/or device 828. A user may view the instructions and/or install the hopper 150. In some embodiments, the hopper 150 is fastened, slidably engaged, or otherwise removably coupled to the concrete mixer truck 10 (e.g., via mounting apertures 146). The hopper 150 may facilitate a direct charge drum assembly 100 being charged by material directed by the hopper 150 into the mixing drum 102.

At a step 1218, a data processing system may receive a mixture into a drum using the removable hopper. The drum charging manager 814 may reposition the chute 400 in a target accommodating position and/or the mixing drum 102 as described above. In some embodiments, the chute 400 is fixed relative to the frame 202, and the opening of the mixing drum 102 is fixed relative to the frame 12. In such embodiments, the hopper 150 may facilitate charging the mixing drum 102 with material.

At a step 1220, the data processing system may deliver concrete to a jobsite, according to some embodiments. A concrete mixer truck 10 having a mixture within the mixing drum 102 may facilitate a user transporting the mixture to the jobsite. The drum mixture manager 810 may monitor and adjust a characteristic of a mixture of materials within the mixing drum 102 during transit to the jobsite. The drum mixture manager 810 may control the drum drive system 858 to dispense the material form the mixing drum 102 in response to a user input, an automatically generated signal, and/or a remote signal (e.g., a signal generated by a user spaced from the concrete mixer truck 10).

At a step 1222, the data processing system may remove the removable hopper, according to some embodiments. The drum charging manager 814 may present information and instructions on a graphical user interface associated with a display of the user interface 830, user device 826, and/or device 828. A user may view the instructions and uninstall the hopper 150. In some embodiments, the hopper 150 is fastened, slidably engaged, magnetically coupled to, removably coupled to, etc., the concrete mixer truck 10 (e.g., via mounting apertures 146). A user may uninstall the hopper 150 from the concrete mixer truck 10. In some embodiments, the hopper 150 may be removed after a job (e.g., task, order, etc.) associated with the batch plant 300 is completed, to thereby maintain a reduced weight and improved efficiency of the direct charge drum assembly 100 of the concrete mixer truck 10.

At a step 1224, the data processing system may determine a state of a different local batch plant, according to some embodiments. The drum charging manager 814 may determine a state of a different batch plant 300 from a list of one or more batch plants 300 that satisfy one or more criteria. For example, the drum charging manager 814 may determine a state of a different batch plant 300 within a predefined distance of the concrete mixer truck 10 and/or jobsite. Subsequent to identifying the state of the different batch plant 300, the process 1200 may continue with step 1206.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various processing steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “lowermost,” “uppermost,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A concrete mixer vehicle, comprising:
a chassis;
a mixing drum assembly coupled to the chassis, the mixing drum assembly comprising:
a mixing drum defining an aperture configured to receive a material and a volume configured to contain the material;
a mixing element positioned within the volume and coupled to the mixing drum, wherein the mixing element is configured to mix the material when the mixing drum is rotated in a first direction, thereby mixing the material, and wherein the mixing element is configured to drive the material towards the aperture when the mixing drum is rotated in a second direction opposite the first direction;
a collector positioned to receive the material from the mixing drum; and
a chute positioned to receive the material from the collector; and
a controller configured to:
determine a state of the concrete mixer vehicle;
determine a state of a mixture delivery system of a batch plant; and
based on the state of the concrete mixer vehicle and the state of the mixture delivery system: (i) obtain a setpoint value for an actuator of the concrete mixer vehicle or the mixture delivery system, the setpoint value associated with a position of the actuator such that an outlet of the mixture delivery system is disposed within the volume, (ii) apply the setpoint value to the actuator of the concrete mixer vehicle or the mixture delivery system to position the outlet of the mixture delivery system within the volume, and (iii) activate the mixture delivery system to output material through the outlet of the mixture delivery system such that the material is deposited directly into the volume of the mixing drum to thereby directly charge the concrete mixer vehicle with the material.

2. The concrete mixer vehicle of claim 1, further comprising:
an auxiliary fluid system comprising:
a tank configured to store a fluid;
a pump to pressurize the fluid;
a fluid valve in fluid communication with the tank, the fluid valve operable between an open position and a closed position; and
a fluid outlet associated with the fluid valve;
wherein the controller is further configured to:
based on the state of the concrete mixer vehicle: activate the fluid valve and the pump such that the fluid outlet provides the fluid to a target location of the concrete mixer vehicle.

3. The concrete mixer vehicle of claim 2, wherein the target location of the concrete mixer vehicle is the volume of the mixing drum, and wherein the fluid is water.

4. The concrete mixer vehicle of claim 2, wherein the target location of the concrete mixer vehicle is the volume of the mixing drum, and wherein the fluid is an admixture material configured to adjust a parameter of the mixture.

5. The concrete mixer vehicle of claim 2, wherein the fluid outlet is a plurality of nozzles positioned to provide the fluid to the target location when the fluid valve is selectively activated to the open position.

6. The concrete mixer vehicle of claim 2, wherein the controller is configured to: receive a user input to activate the fluid valve and the pump such that the fluid outlet provides the fluid to the target location of the concrete mixer vehicle.

7. The concrete mixer vehicle of claim 1, wherein determining the state of the concrete mixer vehicle comprises: determining a concrete mixer vehicle location, and determining a mixing drum position and orientation.

8. The concrete mixer vehicle of claim 1, wherein determining the state of the mixture delivery system of the batch plant comprises: determining an operational envelope of the mixture delivery system.

9. The concrete mixer vehicle of claim 1, wherein obtaining the setpoint value for the actuator of the concrete mixer vehicle or the mixture delivery system of the batch plant comprises:
comparing a determined mixing drum position and orientation to a determined operational enveloped of the mixture delivery system; and
based on the comparison, determining a setpoint value for positioning the outlet of the mixture delivery system within the mixing drum.

10. The concrete mixer vehicle of claim 1, wherein obtaining the setpoint value for the actuator of the concrete mixer vehicle of the mixture delivery system of the batch plant comprises:
retrieving the setpoint value from a database based on the determined state of the concrete mixer vehicle and the determined state of the mixture delivery system of the batch plant.

11. The concrete mixer vehicle of claim 1, wherein the mixing drum is pivotable between a first position and a second position angularly offset from the first position and the chassis, wherein the concrete mixer vehicle further comprises the actuator coupled to the chassis and the mixing drum for selectively positioning the mixing drum between the first position and the second position.

12. The concrete mixer vehicle of claim 1, further comprising a sensor proximate the aperture of the mixing drum, wherein the sensor is configured to detect a position of the outlet of the mixture delivery system relative to the sensor; wherein the controller is further configured to determine a location of the outlet of the mixture delivery system relative to the aperture of the mixing drum based at least partially on the sensor.

13. The concrete mixer vehicle of claim 1, further comprising a washout system, the washout system comprising:
a tank configured to store a fluid;
a plurality of electronically controllable valves that are in fluid communication with the tank, the plurality of electronically controllable valves operable between an open position and a closed position;
a plurality of nozzles, one or more of the plurality of nozzles fluidly coupled to a respective one of the plurality of electronically controllable valves, each of the plurality of nozzles positioned to provide the fluid to a respective target when the respective one of the plurality of electronically controllable valves is selectively activated to the open position;
wherein the controller is configured to activate one or more of the plurality of electronically controllable valves based on the determined state of the concrete mixer vehicle.

14. A batch plant, comprising:
a frame;
a cement supply;
an aggregate supply;
a mixture delivery system comprising:
a mixture output mechanism having an inlet and an outlet, wherein the outlet is selectively repositionable relative to the frame; and
a controller configured to:
determine a state of a mixing drum proximate the outlet of the mixture output mechanism;
determine a state of the mixture output mechanism; and
based on the state of the mixing drum and the mixture delivery system: (i) obtain a setpoint value for an actuator of the mixture delivery system, the setpoint value associated with a position of the mixture output mechanism such that the outlet is disposed within a volume of the mixing drum, (ii) apply the setpoint value to the actuator of the mixture delivery system, and (iii) activate the mixture delivery system to dispense material directly into the volume.

15. The batch plant of claim 14, wherein obtaining a setpoint value for the actuator of the mixture output mechanism comprises:
comparing a determined position of the mixture output mechanism and a determined position of an inlet of the mixing drum; and
based on the comparison, determining the setpoint value associated with the opening being disposed within the volume.

16. The batch plant of claim 14, wherein obtaining a setpoint value for the actuator of the mixture output mechanism comprises retrieving a setpoint value from a database based on the determined state of the mixing drum and the determined state of the mixture output mechanism.

17. The batch plant of claim 14, wherein the mixture output mechanism comprises:
a first section defining the inlet; and
a second section defining the outlet;
wherein the first section is coupled to the second section and movable relative to the frame; and
wherein the second section is moveable relative to the frame and the second section.

18. The batch plant of claim 14, wherein the mixture output mechanism comprises:
a first actuator configured to adjust the position of the inlet relative to the frame; and
a second actuator configured to adjust the position of the outlet relative to the inlet.

19. A concrete mixer vehicle, comprising:
a chassis;
a mixing drum assembly coupled to the chassis, the mixing drum assembly comprising:
a mixing drum defining an aperture configured to receive a material and a volume configured to contain the material;
a mixing element positioned within the volume and coupled to the mixing drum;
a pedestal coupled to the chassis and configured to support the mixing drum, the pedestal defining a mount for removably attaching an accessory to the pedestal;
a collector positioned to receive material from the mixing drum; and
a chute positioned to receive the material from the collector;
an auxiliary fluid system comprising:
an admixture system configured to selectively add an admixture material to the mixing drum; and
a washout system configured to wash at least one of an interior of the mixing drum, an exterior surface of the mixing drum, the collector, or the chute;
a user access point coupled to the chassis; and
a controller configured to:
obtain a setpoint value for an actuator of the concrete mixer vehicle, the setpoint value associated with a position of the actuator such that an outlet of a mixture delivery system of a batch plant is disposed within the volume,
apply the setpoint value to the actuator of the concrete mixer vehicle, and
activate the mixture delivery system of the batch plant to output material directly into the volume of the mixing drum to thereby directly charge the concrete mixer vehicle with material.

20. The concrete mixer vehicle of claim 19, wherein the concrete mixer vehicle further comprises a sensor proximate the aperture, the sensor configured to detect a position of the outlet of the mixture delivery system of the batch plant; and
wherein the controller is further configured to control one or more actuators associated with the outlet to selectively reposition the outlet relative to the aperture of the mixing drum based on the position detected by the sensor.
